(19) United States
(12) Patent Application Publication
(10) Pub. No.: US 2018/0298914 A1
(43) Pub. Date: Oct. 18, 2018

(54) BLOWER

(71) Applicant: DENSO CORPORATION, Kariya-city, Aichi-pref. (JP)

(72) Inventors: Takahito NAKAMURA, Kariya-city (JP); Yasuhiro SEKITO, Kariya-city (JP); Daisuke SAKAKIBARA, Kariya-city (JP)

(21) Appl. No.: 15/569,418

(22) PCT Filed: Apr. 7, 2016
(86) PCT No.: PCT/JP2016/061452

§ 371 Date: Oct. 26, 2017

(30) Foreign Application Priority Data
Apr. 28, 2015 (JP) 2015-091638

(51) Int. Cl. F04D 29/42; F04D 25/16; F04D 25/08; B60H 1/00

(52) U.S. Cl. CPC F04D 29/4246; F04D 25/166; B60H 1/00564; B60H 1/00464; F04D 25/08

(57) ABSTRACT

A blower includes a fan that rotates about an axis center in an air conditioning case, and a casing that guides air blown from the fan. The casing has a peripheral wall that is located radially outward of the fan with the axis center as a center. The peripheral wall has first and second scroll inner wall surfaces that guide different kinds of air blown from the fan to different outlets. No half-lines starting from the axis center passes through both of the first and second scroll inner wall surfaces.

### CROSS REFERENCE TO RELATED APPLICATION

The present application is based on Japanese patent application No. 2015-91638 filed on Apr. 28, 2015, the content of which is incorporated herein by reference.

### TECHNICAL FIELD

The present disclosure relates to a blower.

### Background Art

Patent Literature 1 discloses a blower that guides two types of blown air having different temperatures to different blowing ports. Specifically, the blown air of the two types is hot air and cold air. In the blower, a partitioning member is disposed inside a casing surrounding a centrifugal fan so that a passage for each of the two kinds of blown air is provided, thereby being capable of guiding the two types of blown air to the different blowing ports.

### PRIOR ART LITERATURES

### Patent Literature

Patent Literature 1: JP H5-39810 B2

### SUMMARY OF INVENTION

However, with the configuration described above, since the two passages are disposed in the same direction when viewed from a rotation center of the centrifugal fan, a size of the casing tends to be large.

In view of the above difficulties, an object of the present disclosure is to reduce a size of a casing in a blower that guides two or more types of blown air having different temperatures to different blowing ports, as compared with that of a conventional blower.

In one aspect for achieving the above objects, a blower includes a fan that suctions and blows a plurality of kinds of blown air at different temperatures while rotating around an axis center, and a casing that guides the plurality of kinds of blown air blown out from the fan. The casing includes a peripheral wall that is located radially outward of the fan with the axis center as a center, and the peripheral wall includes a first scroll inner wall surface that curves and extends in a shape surrounding the axis center and a second scroll inner wall surface that curves and extends in a shape surrounding the axis center. The first scroll inner wall surface is formed in a shape that guides a first type of blown air blown from the fan to a first outlet space. The second scroll inner wall surface is formed in a shape that guides a second type of blown air blown from the fan and different in temperature from the first type of blown air to a second outlet space different from the first outlet space. The first scroll inner wall surface and the second scroll inner wall surface are disposed so as not to overlap with each other in a radial direction starting from the axis center.

With the above configuration, there is no case in which the scroll space is further wound outside the scroll space as viewed from an axis center, and conversely the scroll space is further wound outside the scroll space. Therefore, the size of the casing can be kept small.

Further, in another aspect, a blower includes a fan that suctions and blows a plurality of kinds of blown air at different temperatures while rotating around an axis center, and a casing that guides the plurality of kinds of blown air blown out from the fan. The casing includes a peripheral wall that is located radially outward of the fan with the axis center as a center. The peripheral wall includes a first scroll inner wall surface that curves and extends in a shape surrounding the axis center and a second scroll inner wall surface that curves and extends in a shape surrounding the axis center. The first scroll inner wall surface is formed in a shape that guides a first type of blown air blown from the fan to a first outlet space, and the second scroll inner wall surface is formed in a shape that guides a second type of blown air blown from the fan and different in temperature from the first type of blown air to a second outlet space different from the first outlet space. The first scroll inner wall surface extends from the first nose portion located on the upstream side of the flow of the first kind of blown air to the downstream side of the flow of the first kind of blown air, and a back surface side of the first nose portion on the peripheral wall faces a space in which air outside the casing is present. The second scroll inner wall surface extends from the second nose portion located on the upstream side of the flow of the second kind of blown air to the downstream side of the flow of the first kind of blown air, and a back surface side of the second nose portion on the peripheral wall faces the space in which the air outside the casing is present.

### BRIEF DESCRIPTION OF DRAWINGS

FIG. 1 is a cross-sectional view illustrating an air conditioning unit according to a first embodiment.

FIG. 2 is a cross-sectional view taken along a line II-II in FIG. 1.

FIG. 3 is a cross-sectional view taken line III-III of FIG. 1.

FIG. 4 is a cross-sectional view of a line IV-IV in FIG. 1.

FIG. 5 is a cross-sectional view taken along a line V-V in FIG. 1.

FIG. 6 illustrates a comparative example.

FIG. 7 is a cross-sectional view illustrating an air conditioning unit according to a second embodiment.

FIG. 8 is a cross-sectional view of a line VIII-VIII in FIG. 7.

FIG. 9 is a cross-sectional view of a line IX-IX in FIG. 7.

FIG. 10 is a cross-sectional view taken along a line X-X in FIG. 7.

FIG. 11 is a cross-sectional view taken along a line XI-XI in FIG. 7.

FIG. 12 is an end view taken along a line XII-XII in FIG. 7.

FIG. 13 is a cross-sectional view taken along a line XIII-XIII in FIG. 7.

FIG. 14 is a cross-sectional view taken along a line IV-IV of FIG. 7.

FIG. 15 is a cross-sectional view illustrating an air conditioning unit according to another embodiment.

FIG. 16 is a cross-sectional view illustrating an air conditioning unit according to another embodiment.

### DESCRIPTION OF EMBODIMENTS

Hereinafter, multiple embodiments will be described with reference to the drawings. In each of the following embodiments, parts that are the same as or equivalent to those described in the preceding embodiment are denoted by the same reference numerals, and a description of the same parts may be omitted. Also, in each of the embodiments, when only a part of the components is described, the components described in the preceding embodiments can be applied to the other parts of the components.

### First Embodiment

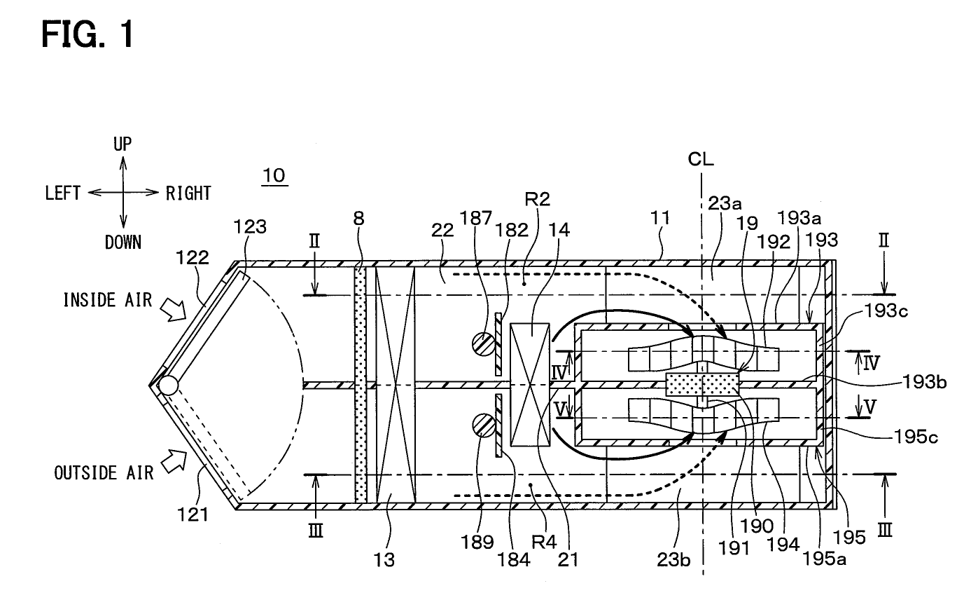

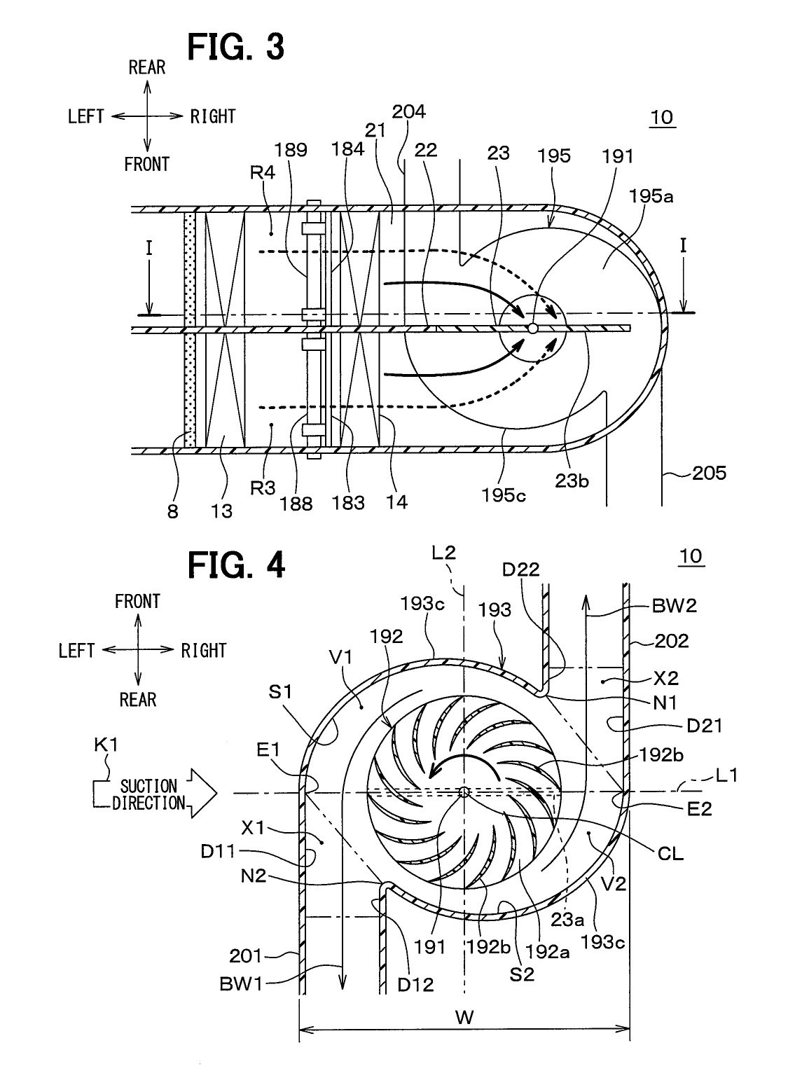

Hereinafter, a description will be given of a first embodiment with reference to FIGS. 1 to 5. In the present embodiment, an example in which a vehicle air conditioning apparatus that performs air conditioning in a vehicle interior is applied to a vehicle will be described. As shown in FIG. 1, the vehicle air conditioning apparatus includes an air conditioning unit 10 as a main component. FIG. 1 is a cross-sectional view of the air conditioning unit 10 according to the present embodiment in a cross section perpendicular to a longitudinal direction of a vehicle on which the air conditioning unit 10 is mounted.

Up and down directions shown in FIG. 1 indicate upward and downward directions of the vehicle when the vehicle air conditioning apparatus is mounted on the vehicle. Right and left arrows shown in FIG. 1 indicate right and left directions of the vehicle when the vehicle air conditioning apparatus is mounted on the vehicle. The same is applied to the other drawings. Further, in the other figures, front and rear arrows indicate a forward direction and a rearward direction when the vehicle air conditioning apparatus is mounted in the vehicle.

The air conditioning unit 10 is disposed in the vehicle interior. More specifically, the air conditioning unit 10 is disposed in a dashboard and in a lower portion of an instrument panel (that is, the instrument panel). In the air conditioning unit 10, an evaporator 13, a heater core 14, and the like are housed inside an air conditioning case 11 forming an outer shell of the air conditioning unit 10.

The air conditioning case 11 is a cylindrical shaped case forming an air flow passage for the blown air blown into a vehicle interior. The air conditioning case 11 according to the present embodiment is made of a resin (for example, polypropylene) having a certain degree of elasticity and also excellent strength.

An outside air introduction port 121 for introducing an outside air which is an air outside the vehicle and an inside air introduction port 122 for introducing a vehicle interior air are provided at the most upstream side of an air flow in the air conditioning case 11.

An inside/outside air switching door 123 is disposed on an air flow downstream side of the outside air introduction port 121 and the inside air introduction port 122 in the air conditioning case 11. The inside/outside air switching door 123 is a damper that adjusts opening areas of the respective introduction ports 121 and 122 to change the ratio of an introduction air volume of the outside air and an introduction air volume of the inside air. The inside/outside air switching door 123 is rotatably disposed between the outside air introduction port 121 and the inside air introduction port 122, and is driven by an actuator not shown.

An air filter 8 is disposed on the air flow downstream side of the inside/outside air switching door 123 in the air conditioning case 11. The air filter 8 is a plate-shaped member that is fixed to an inner surface of the air conditioning case 11, and is made of a paper material or a nonwoven fabric of a resin material. The air filter 8 removes powder dust and dust in the air that has entered the air conditioning case 11 from the outside air introduction port 121 and the inside air introduction port 122 to filter the air.

An evaporator 13 that forms a cooling unit for cooling the blown air blown into the vehicle interior is disposed on the air flow downstream side of the air filter 8 in the air conditioning case 11. The evaporator 13 is a heat exchanger for cooling the blown air while absorbing a latent heat of evaporation of a low-temperature refrigerant flowing inside from the blown air in the air conditioning case 11, and forms a vapor compression type refrigeration cycle in cooperation with a compressor, a condenser, and a pressure reduction mechanism not shown.

The evaporator 13 that forms a heating unit for heating the blown air blown into the vehicle interior is disposed on the air flow downstream side of the evaporator 13 in the air conditioning case 11. The heater core 14 is a heat exchanger for heating the blown air in the air conditioning case 11 with a coolant of an engine of a vehicle not shown as a heat source.

An upper and lower partition plate 21 is extended from immediately downstream in the air flow of the inside/outside air switching door 123 to a centrifugal blower 19 in the air conditioning case 11. The upper and lower partition plate 21 is a flat plate shaped resin member that is fixed to the air conditioning case 11, and a plate surface of the upper and lower partition plate 21 is perpendicular to a vertical direction of the vehicle. With the upper and lower partition plate 21, a space from the inside/outside air switching door 123 to the centrifugal blower 19 in a space through which the blown air flows in the air conditioning case 11 is partitioned into the upper and lower parts of the vehicle.

Further, an upper side suction port partition plate 23a that is shaped in a flat plate and made of resin is disposed above the centrifugal blower 19 in the vehicle and on a right side of the upper and lower partition plates 21 in the vehicle. The upper side suction port partition plate 23a is fixed to an inner surface of the air conditioning case 11. The upper side suction port partition plate 23a is a member separated from the upper and lower partition plate 21 and is not fixed to the upper and lower partition plate 21. A vehicle right side end of the upper and lower partition plate 21 and a vehicle left side end of the upper side suction port partition plate 23a come in contact with each other or are adjacent to each other across a minute air gap. In addition, the upper and lower partition plate 21 and the upper side suction port partition plate 23a are parallel to each other, and the upper and lower partition plate 21 and the upper side suction port partition plate 23a form one flat plate.

Further, a lower side suction port partition plate 23b that is shaped in a flat plate and made of resin is disposed below the centrifugal blower 19 in the vehicle and on a right side of the upper and lower partition plates 21 in the vehicle. The lower side suction port partition plate 23b is fixed to the inner surface of the air conditioning case 11. The lower side suction port partition plate 23b is a member separated from the upper and lower partition plate 21 and is not fixed to the upper and lower partition plate 21. The vehicle right side end of the upper and lower partition plate 21 and a vehicle left side end of the lower side suction port partition plate 23b come in contact with each other or are adjacent to each other across a minute air gap. In addition, the upper and lower partition plate 21 and the lower side suction port partition plate 23b are parallel to each other, and the upper and lower partition plate 21 and the lower side suction port partition plate 23b form one flat plate.

A front and rear partition plate 22 is extended from immediately downstream in the air flow of the inside/outside air switching door 123 to an end portion of the centrifugal blower 19 on the vehicle left side in the air conditioning case 11. The front and rear partition plate 22 is a flat plate shaped resin member that is fixed to the air conditioning case 11, and a plate surface of the front and rear partition plate 22 is perpendicular to a longitudinal direction of the vehicle. With the front and rear partition plate 22, the space from the inside/outside air switching door 123 to the centrifugal blower 19 in the space through which the blown air flows in the air conditioning case 11 is partitioned into front and rear parts of the vehicle.

The upper and lower partition plate 21 and the front and rear partition plate 22 vertically intersect with each other in the air conditioning case 11. Therefore, in the space through which the blown air flows in the air conditioning case 11, the space extending from the inside/outside air switching door 123 to the vehicle upper side and the vehicle lower side of the centrifugal blower 19 is separated into four spaces including an upper front side space R1, an upper rear side space R2, a lower front side space R3, and a lower rear side space R4 by the aid of the upper and lower partition plates 21, the front and rear partition plate 22, the upper side suction port partition plate 23a, and the lower side suction port partition plate 23b.

More specifically, the upper and lower partition plate 21 separates the spaces R1 and R2 from the respective spaces R3 and R4, and the front and rear partition plate 22 separates the spaces R1 and R3 from the respective spaces R2 and R4. Further, the upper side suction port partition plate 23a separates the space R1 from the space R2, and the lower side suction port partition plate 23b separates the space R3 from the space R4.

The air filter 8, the evaporator 13, and the heater core 14 described above are disposed to penetrate through the upper and lower partition plates 21 and the front and rear partition plate 22, and are present inside all of the upper front side space R1, the upper rear side space R2, the lower front side space R3, and the lower rear side space R4 described above.

An upper front side air mixing door 181 and an upper front side door shaft 186 for adjusting an air volume ratio of cold air and hot air in the upper front side space R1 are disposed on the air flow downstream side of the evaporator 13 and the air flow upstream side of the heater core 14 in the upper front side space R1.

The upper front side air mixing door 181 is a plate-shaped resin member, and is connected to the upper front side door shaft 186 so as to be displaceable in the vehicle vertical direction relative to the upper front side door shaft 186. The upper front side door shaft 186 is rotationally driven by an actuator not shown and displaces the upper front side air mixing door 181 in the vehicle vertical direction. As a result, the air volume ratio of the cold air that is a blown air blown into the heater core 14 through the evaporator 13 and the hot air that bypasses the heater core 14 through the evaporator 13 can be adjusted in the upper front side space R1.

In addition, an upper rear side air mixing door 182 and an upper rear side door shaft 187 for adjusting the air volume ratio of the cold air and the hot air in the upper rear side space R2 are disposed on the air flow downstream side of the evaporator 13 and the air flow upstream side of the heater core 14 in the upper rear side space R2. The configurations and functions of the upper rear side air mixing door 182 and the upper rear side door shaft 187 are comparable to those of the upper front side air mixing door 181 and the upper rear side air mixing door 182, respectively.

In addition, a lower front side air mixing door 183 and a lower front side door shaft 188 for adjusting an air volume ratio of the cold air and the hot air in the lower front side space R3 are disposed on the air flow downstream side of the evaporator 13 and the air flow upstream side of the heater core 14 in the lower front side space R3. The configurations and functions of the lower front side air mixing door 183 and the lower front side door shaft 188 are comparable to those of the upper front side air mixing door 181 and the upper rear side air mixing door 182, respectively.

A lower rear side air mixing door 184 and a lower rear side door shaft 189 are disposed on the air flow downstream side of the evaporator 13 and on the air flow upstream side of the heater core 14 in the lower rear side space R4. The lower rear side air mixing door 184 and the lower rear side door shaft 189 are members for adjusting the air volume ratio of the cold air and the hot air in the lower rear side space R4. The configurations and functions of the lower rear side air mixing door 184 and the lower rear side door shaft 189 are comparable to those of the upper front side air mixing door 181 and the upper rear side air mixing door 182, respectively.

The respective door shafts 186 to 189 are driven independently, that is, any one door shaft is driven without being influenced by the other door shafts. Therefore, the positions of those air mixing doors 181 to 184 are adjusted independently, that is, the position of any one air mixing door is not influenced by the positions of the other air mixing doors.

Therefore, in some cases, temperatures of the blown air flowing into the centrifugal blower 19 from the upper front side space R1, the upper rear side space R2, the lower front side space R3, and the lower rear side space R4 are different from each other in all of the upper front side space R1, the upper rear side space R2, the lower front side space R3, and the lower rear side space R4. In addition, in some cases, temperatures of the blown air flowing into the centrifugal blower 19 from the upper front side space R1, the upper rear side space R2, the lower front side space R3, and the lower rear side space R4 are identical with each other in all of the upper front side space R1, the upper rear side space R2, the lower front side space R3, and the lower rear side space R4.

As an example, an example in which the inside/outside air switching door 123 is in an inside and outside air bilayer mode position where both of the inside air and the outside air are introduced will be described. In this example, the inside air and the outside air are separated by the inside/outside air switching door 123 and the upper and lower partition plate 21. The inside air flows into the upper front side space R1 and the upper rear side space R2, and the outside air flows into the lower front side space R3 and the lower rear side space R4. Further, in this example, the positions of the upper front side air mixing door 181 and the upper rear side air mixing door 182 are adjusted so that the air volume ratio of the cold air and the hot air is different between the upper front side space R1 and the upper rear side space R2. In addition, in this example, the positions of the lower front side air mixing door 183 and the lower rear side air mixing door 184 are adjusted so that the air volume ratio of the cold air and the hot air is different between the lower front side space R3 and the lower rear side space R4. Therefore, in this example, the temperature of the blown air flowing into the centrifugal blower 19 from the upper front side space R1 is different from the temperature of the blown air flowing into the centrifugal blower 19 from the upper rear side space R2. In addition, in this example, the temperature of the blown air flowing into the centrifugal blower 19 from the lower front side space R3 is different from the temperature of the blown air flowing into the centrifugal blower 19 from the lower rear side space R4.

The centrifugal blower 19 is disposed on the air flow downstream side of the heater core 14 in each of the upper front side space R1, the upper rear side space R2, the lower front side space R3, and the lower rear side space R4. The centrifugal blower 19 suctions the air flowing through each of the aforementioned spaces and blows the suctioned air out of the air conditioning case 11.

In this manner, in the internal space of the air conditioning case 11, the inside/outside air switching door 123, the air filter 8, the evaporator 13, the four door shafts 186 to 189, the four air mixing doors 181 to 184, the heater core 14, and the centrifugal blower 19 are aligned from upstream toward downstream of the air flow direction, in the longitudinal direction of the internal space in the stated order.

The details of the centrifugal blower 19 will be described below. The centrifugal blower 19 includes a motor 190, a rotating shaft 191, an upper centrifugal multi-blade fan 192, an upper scroll casing 193, a lower centrifugal multi-blade fan 194, and a lower scroll casing 195.

The motor 190 is disposed between the upper centrifugal multi-blade fan 192 and the lower centrifugal multi-blade fan 194 in the air conditioning case 11. The rotating shaft 191 corresponding to an output shaft of the motor 190 extends from a motor housing of the motor 190 to both of the upper centrifugal multi-blade fan 192 side and the lower centrifugal multi-blade fan 194 side. When the motor 190 is operated, the rotating shaft 191 is rotationally driven. The rotating shaft 191 is formed of a rod-shaped metal member, and is connected to the upper centrifugal multi-blade fan 192 at one end and to the lower centrifugal multi-blade fan 194 at the other end. As another example, the motor 190 may be disposed outside the air conditioning case 11.

The rotating shaft 191 is driven by the motor 190 to rotate about an axis center CL, thereby transmitting a rotational torque generated by the motor 190 to the centrifugal multi-blade fans 192 and 194. The axis center CL is parallel to the vehicle vertical direction.

The upper scroll casing 193 is a housing that is disposed in the air conditioning case 11 as shown in FIGS. 1, 2, and 4, and houses a part of the rotating shaft 191 and the upper centrifugal multi-blade fan 192. The upper scroll casing 193 includes an air introduction side bottom wall 193a, an opposite side bottom wall 193b, and a scroll outer peripheral wall 193c.

The air introduction side bottom wall 193a is a plate-shaped resin member that is orthogonal to the vertical direction of the vehicle, and an inner peripheral end portion present at a center of the member surrounds a communication hole. The communication hole is a hole that communicates an internal space of the upper scroll casing 193 with the upper front side space R1 and the upper rear side space R2.

The opposite side bottom wall 193b is a plate-shaped resin member that is orthogonal to the vertical direction of the vehicle and faces the air introduction side bottom wall 193a in the vehicle vertical direction. Unlike the air introduction side bottom wall 193a, the opposite side bottom wall 193b is not drilled. Further, the opposite side bottom wall 193b is integrally connected to the upper and lower partition plate 21, and partitions the space inside the air conditioning case 11 into upper and lower parts in cooperation with the upper and lower partition plate 21.

The scroll outer peripheral wall 193c is a plate-shaped resin member forming an outer periphery of the upper scroll casing 193. The scroll outer peripheral wall 193c is connected to an outer peripheral end of the air introduction side bottom wall 193a at a vehicle upper end which is one end of the scroll outer peripheral wall 193c, and connected to an outer peripheral end of the opposite side bottom wall 193b at a vehicle lower end which is the other end of the scroll outer peripheral wall 193c. Therefore, the scroll outer peripheral wall 193c is a member that connects the air introduction side bottom wall 193a and the opposite side bottom wall 193b. The scroll outer peripheral wall 193c is located radially outward with the axis center CL as a center as compared with the upper centrifugal multi-blade fan 192.

A space surrounded by the air introduction side bottom wall 193a, the opposite side bottom wall 193b, and the scroll outer peripheral wall 193c is an internal space of the upper scroll casing 193.

Further, the upper scroll casing 193 is connected to two resin ducts 201 and 202. The internal space of the upper scroll casing 193 communicates with the internal spaces of those ducts 201 and 202. Each of the ducts 201 and 202 is a pipe arranged outside the air conditioning case 11 and inside the dashboard, one end of which opens into the internal space of the upper scroll casing 193 and the other end of which opens into the vehicle interior. Therefore, the blown air blown out from the internal space of the upper scroll casing 193 passes through those ducts 201 and 201 and is blown into the vehicle interior.

The upper centrifugal multi-blade fan 192 is a member that is accommodated in the internal space of the upper scroll casing 193, draws the blown air while rotating about the axis center CL and blows the blown air in a direction away from the axis center CL. As shown in FIG. 4, the upper centrifugal multi-blade fan 192 includes a boss portion 192a, multiple (for example, 40) blades 192b, and a top plate portion not shown. The upper centrifugal multi-blade fan 192 may be configured by a sirocco fan or a turbo fan.

The boss portion 192a is a plate-shaped resin member, and a center portion of the boss portion 192a is fixed to the rotating shaft 191. The boss portion 192a has a convex shape in a vehicle upward direction with a portion connected to the rotating shaft 191 as a vertex, that is, a convex shape in a direction of a communication hole drilled in the air introduction side bottom wall 193a along the axis center CL. Further, the boss portion 192a is rotatable together with the rotating shaft 191.

The multiple blades 192b are flat-plate resin members that are arranged circumferentially at regular intervals in a circumferential direction around a columnar fan suction space with the fan axis center CL as a center. The fan suction space is a space including the fan axis center CL and a space in the vicinity of the fan axis center CL in the internal space of the upper scroll casing 193. Each of the blades 192b is connected and fixed to the boss portion 192a so as to be perpendicular to the boss portion 192a and so that the blown air is led in a direction away from the fan axis center CL (that is, not to be perpendicular to the radial direction with the fan axis center CL as the center). Therefore, those multiple blades 192b rotate integrally with the boss portion 192a.

The top plate is formed of an annular plate shaped resin member that faces the boss portion 192a across the multiple blades 192b, and all of the blades 192b are connected and fixed to the top plate. Accordingly, the top plate rotates integrally with the multiple blades 192b and the boss portion 192a.

The lower scroll casing 195 is a housing that is disposed in the air conditioning case 11 as shown in FIGS. 1, 3, and 5, and houses a part of the rotating shaft 191 and the lower centrifugal multi-blade fan 194. The lower scroll casing 195 includes an air introduction side bottom wall 195a, the opposite side bottom wall 193b, and a scroll outer peripheral wall 195c. The opposite side bottom wall 193b is a member shared by the upper scroll casing 193 and the lower scroll casing 195.

The air introduction side bottom wall 195a is a plate-shaped resin member that is orthogonal to the vertical direction of the vehicle, and an inner peripheral end portion present at a center of the member surrounds a communication hole. The communication hole is a hole that communicates an internal space of the lower scroll casing 195 with the lower front side space R3 and the lower rear side space R4. The opposite side bottom wall 193b also faces the air introduction side bottom wall 195a in the vehicle vertical direction.

The scroll outer peripheral wall 195c is a plate-shaped resin member forming an outer periphery of the lower scroll casing 195. The scroll outer peripheral wall 195c is connected to an outer peripheral end of the air introduction side bottom wall 195a at a vehicle lower end which is one end of the scroll outer peripheral wall 195c, and connected to an outer peripheral end of the opposite side bottom wall 193b at a vehicle upper end which is the other end of the scroll outer peripheral wall 195c. Therefore, the scroll outer peripheral wall 195c is a member that connects the air introduction side bottom wall 195a and the opposite side bottom wall 193b. The scroll outer peripheral wall 195c is located radially outward with the axis center CL as a center as compared with the upper centrifugal multi-blade fan 192.

A space surrounded by the air introduction side bottom wall 195a, the opposite side bottom wall 193b, and the scroll outer peripheral wall 195c is an internal space of the lower scroll casing 195.

Further, the lower scroll casing 195 is connected to two resin ducts 204 and 205. The internal space of the lower scroll casing 195 communicates with the internal spaces of those ducts 204 and 205. Each of the ducts 204 and 205 is a pipe arranged outside the air conditioning case 11 and inside the dashboard, one end of which opens into the internal space of the lower scroll casing 195 and the other end of which opens into the vehicle interior. Therefore, the blown air blown out from the internal space of the lower scroll casing 195 passes through those ducts 204 and 205 and is blown into the vehicle interior.

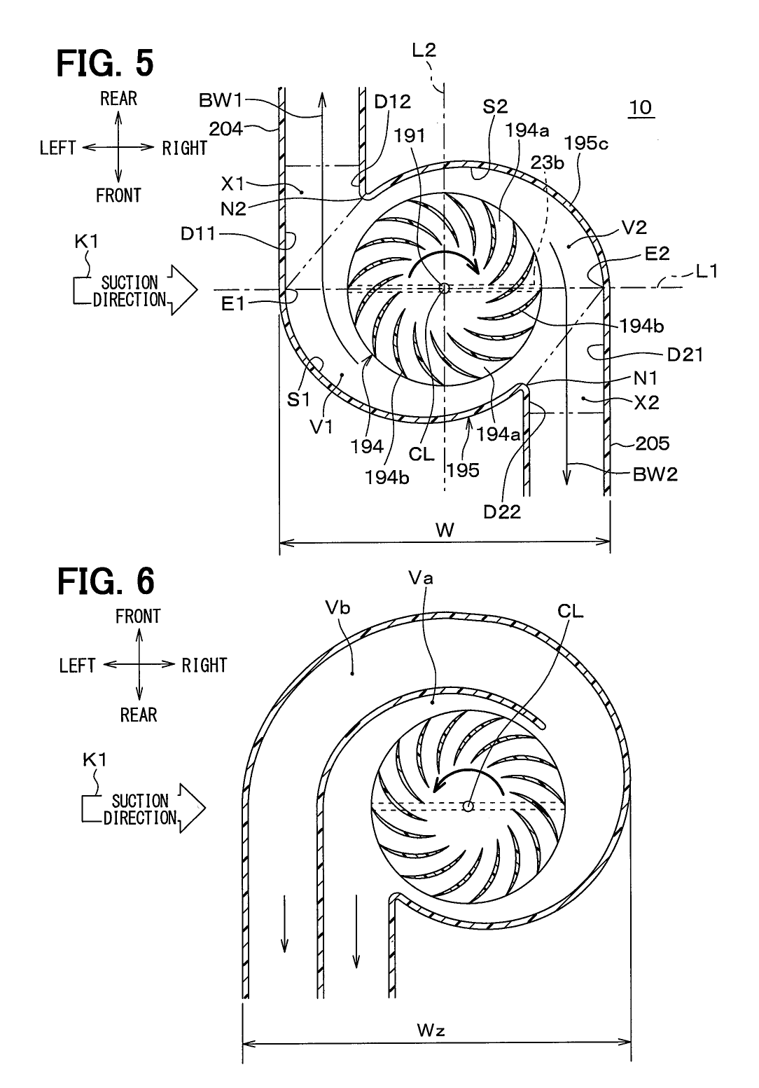

The lower centrifugal multi-blade fan 194 is a member that is accommodated in the internal space of the lower scroll casing 195, draws the blown air while rotating about the axis center CL and blows the blown air in a direction away from the axis center CL. As shown in FIG. 5, the lower centrifugal multi-blade fan 194 includes a boss portion 194a, multiple (for example, 40) blades 194b, and a top plate portion not shown. The lower centrifugal multi-blade fan 194 may be configured by a sirocco fan or a turbo fan.

The boss portion 194a is a plate-shaped resin member, and a center portion of the boss portion 192a is fixed to the rotating shaft 191. The boss portion 194a has a convex shape in a vehicle downward direction with a portion connected to the rotating shaft 191 as a vertex, that is, a convex shape in a direction of a communication hole drilled in the air introduction side bottom wall 195a along the axis center CL. Further, the boss portion 194a is rotatable together with the rotating shaft 191.

Since the configuration of the multiple blades 194b and the connection configuration of the multiple blades 194b to the boss portion 194a are the same as the configuration of the multiple blades 192b and the connection configuration of the multiple blades 194b to the boss portion 192a, a description of those configurations will be omitted. Since the configuration of the top plate of the lower centrifugal multi-blade fans 194 and the connection configuration of the top plate to the multiple blades 194b are the same as the configuration of the top plate of the upper centrifugal multi-blade fan 192 and the connection configuration of the top plate to the multiple blades 192b, a description of those configuration will be omitted.

Now, the configuration of the upper scroll casing 193 will be described in more detail. As shown in FIG. 4, the scroll outer peripheral wall 193c of the upper scroll casing 193 has two scroll inner wall surfaces S1, S2 and four outlet inner wall surfaces D11, D12, D21, and D22 as surfaces of the upper scroll casing 193 on the internal space side.

The scroll inner wall surface 51 faces a scroll space V1 that guides a blown air BW1 suctioned into the upper centrifugal multi-blade fan 192 after having passed through the upper front side space R1 and then blown out in the internal space of the upper scroll casing 193. The blown air BW1 corresponds to an example of the first kind of blown air.

The scroll inner wall surface S1 extends from the nose portion N1 to a winding end portion E1 so that a distance from the axis center CL increases toward a counterclockwise direction in FIG. 4 according to a well-known logarithmic spiral function with respect to a winding angle around the axis center CL. Therefore, the scroll inner wall surface S1 curves and extends in a shape surrounding the axis center CL. The back side of the nose portion N1

The nose portion N1 is located on the most upstream side in the air flow of the blown air BW1 on the scroll inner wall surface S1 and the winding end portion E1 is located on the most downstream side of the blown air BW1 along the air flow on the scroll inner wall surface S1. The nose portion N1 corresponds to an example of a first nose portion, and the winding end portion E1 corresponds to an example of a first winding end portion. A back surface side of the nose portion N1 on the scroll outer peripheral wall 193c faces a space where the air outside the upper scroll casing 193 is present.

The outlet inner wall surface D11 is a substantially planar surface extending from the winding end portion E1 of the scroll inner wall surface S1 to the outside of the air conditioning case 11. The outlet inner wall surface D12 is a substantially planar surface extending from the nose portion N2 of the scroll inner wall surface S2 to the outside of the air conditioning case 11, and is disposed to face the outlet inner wall surface D11.

An outlet space X1 surrounded by the outlet inner wall surfaces D11, D12, the air introduction side bottom wall 193a, and the opposite side bottom wall 193b communicates with the scroll space V1 and further communicates with the internal space of the duct 201. Therefore, the blown air BW1 blown out from the upper centrifugal multi-blade fan 192 is led to the outlet space X1 through the scroll space V1 and then blown further into the vehicle interior through the internal space of the duct 201. As described above, the scroll inner wall surface S1 is formed in a shape that guides the blown air BW1 blown from the upper centrifugal multi-blade fan 192 to the outlet space X1 and the internal space of the duct 201.

The scroll inner wall surface S2 faces a scroll space V2 that guides a blown air BW2 suctioned into the upper centrifugal multi-blade fan 192 after having passed through the upper rear side space R2 and then blown out in the internal space of the upper scroll casing 193. The blown air BW2 corresponds to an example of the second kind of blown air.

The scroll inner wall surface S2 extends from the nose portion N2 to a winding end portion E2 so that a distance from the axis center CL increases toward a counterclockwise direction in FIG. 4 according to a well-known logarithmic spiral function with respect to a winding angle around the axis center CL. Therefore, the scroll inner wall surface S2 curves and extends in a shape surrounding the axis center CL.

The nose portion N2 is located on the most upstream side in the air flow of the blown air BW2 on the scroll inner wall surface S2 and the winding end portion E2 is located on the most downstream side of the blown air BW2 along the air flow on the scroll inner wall surface S2. The nose portion N2 corresponds to an example of a second nose portion, and the winding end portion E2 corresponds to an example of a second winding end portion. A back surface side of the nose portion N2 on the scroll outer peripheral wall 193c faces a space where the air outside the upper scroll casing 193 is present.

The outlet inner wall surface D21 is a substantially planar surface extending from the winding end portion E2 of the scroll inner wall surface S1 to the outside of the air conditioning case 11. The outlet inner wall surface D22 is a substantially planar surface extending from the nose portion N1 of the scroll inner wall surface S1 to the outside of the air conditioning case 11, and is disposed to face the outlet inner wall surface D21.

The outlet space X1 surrounded by the outlet inner wall surfaces D21, D22, the air introduction side bottom wall 193a, and the opposite side bottom wall 193b communicates with the scroll space V1 and further communicates with the internal space of the duct 201. Therefore, the blown air BW2 blown out from the upper centrifugal multi-blade fan 192 is led to the outlet space X2 different from the outlet space X1 through the scroll space V2 and then blown further into the vehicle interior through the internal space of the duct 202. As described above, the scroll inner wall surface S2 is formed in a shape that guides the blown air BW2 blown from the upper centrifugal multi-blade fan 192 to the outlet space X2 and the internal space of the duct 202.

Two-dot chain lines in FIG. 4 are virtual lines indicating boundaries of the outlet space X1 and the outlet space X2.

Now, a relative placement of the scroll inner wall surface S1 and the scroll inner wall surface S2 will be described. The nose portion N1, the axis center CL, and the nose portion N2 are aligned in a straight line in all of cross sections perpendicular to the axis center CL and intersecting with the nose portions N1 and N2. Further, the winding end portion E1, the axis center CL, and the winding end portion E2 are aligned in a straight line in all of the cross sections perpendicular to the axis center CL and intersecting with the winding end portion E1 and the winding end portion E2. Therefore, as seen from the axis center CL, the scroll inner wall surface S1 and the scroll inner wall surface S2 are disposed on opposite sides.

Cross sections orthogonal to the axis center CL and intersecting with the winding end portion E1, the nose portion N2, and the winding end portion E2 can be defined. In any cross section described above, a direction from the axis center CL to the nose portion N1 is outside of an angle range of the scroll inner wall surface S2 from the nose portion N2 to the winding end portion E2 when viewed from the axis center CL.

Cross sections orthogonal to the axis center CL and intersecting with the winding end portion E2, the nose portion N1, and the winding end portion E1 can be defined. In any cross section described above, a direction from the axis center CL to the nose portion N2 is outside of an angle range of the scroll inner wall surface S1 from the nose portion N1 to the winding end portion E1 when viewed from the axis center CL.

In other words, a direction range of the scroll inner wall surface S1 viewed from the axis center CL and a direction range of the scroll inner wall surface S2 do not overlap with each other at all.

Therefore, all half-lines extending perpendicularly to the axis center CL from a starting point of the axial center CL and passing through the scroll inner wall surface S1 do not pass through the scroll inner wall surface S2. In addition, all half-lines extending perpendicularly to the axis center CL from a starting point of the axial center CL and passing through the scroll inner wall surface S2 do not pass through the scroll inner wall surface S1. In other words, the inner scroll wall surface S1 and the scroll inner wall surface S2 are disposed at positions not overlapping with each other as viewed from the axis center CL. In other words, the scroll inner wall surface S1 and the scroll inner wall surface S2 are disposed so as not to overlap with each other in the radial direction starting from the axis center CL.

The above configuration avoids the concern of a width Wz increasing as a result of the scroll space Vb being further wound around outside of the scroll space Va when viewed from the axis center CL, such as shown in FIG. 6. Therefore, the size of the upper scroll casing 193, more specifically, a width of the upper scroll casing 193 in the direction orthogonal to the axis center CL can be reduced.

In particular, as shown in FIG. 4, since a width W of the upper scroll casing 193 of the internal space of the air conditioning case 11 in a longitudinal direction K1 can be kept small in the air conditioning case 11, the degree of freedom of placement of the other devices in the internal space of the air conditioning case 11 in the longitudinal direction increases.

Now, the placement of the scroll inner wall surfaces S1 and S2 relative to the air conditioning case 11 will be described. In the spaces R1 and R2, the blown air flows along the longitudinal direction of the internal space of the air conditioning case 11, and then flows from the spaces R1 and R2 through the communication hole of the air introduction side bottom wall 193a into the fan suction space. The longitudinal direction is the same as the longitudinal direction of the spaces R1 and R2. Therefore, the longitudinal direction of the internal space of the air conditioning case 11 is the suction direction K1 drawn by the centrifugal blower 19 in the vicinity of at least the centrifugal blower 19. A flow rate vector of the blown air flowing into the fan suction space from the spaces R1 and R2 in this manner includes a component in the suction direction K1.

In this example, in any cross section orthogonal to the axis center CL and intersecting with the nose portion N1, a direction in which the suction direction K1 is orthogonally projected onto the cross section is taken as a positive direction of a coordinate axis X, and a direction orthogonal to the coordinate axis is taken as a direction of a coordinate axis Y. At this time, in any cross section, the nose portion N1 is located in a first quadrant, and the nose portion N2 is located outside of the first quadrant. Specifically, the nose portion N2 is located in a fourth quadrant.

In this case, first, second, third, and fourth quadrants are defined in a cross section orthogonal to the axis center CL and intersecting with the nose portion N1. Assuming that a virtual line that is parallel to the direction in which the suction direction K1 is orthogonally projected onto the cross section and passes through the axis center CL is a line L1, and a virtual line orthogonal to the line L1 and passing through the axis center CL is a line L2, as shown in the fourth, the first to fourth quadrants are four sections obtained by dividing the cross section by the lines L1 and L2.

More specifically, the first quadrant is at the vehicle front side of the line L1 and the vehicle right side of the line L2, and the second quadrant is at the vehicle front side of the line L1 and the vehicle left side of the line L2. In addition, the third quadrant is at the vehicle rear side of the line L1 and the vehicle left side of the line L2, and the fourth quadrant is at the vehicle rear side of the line L1 and the vehicle right side of the line L2.

Therefore, in any cross section orthogonal to the axis center CL and intersecting with the nose portion N1, a direction from the axis center CL to the nose portion N1 is deviated from the direction obtained by orthogonally projecting the suction direction K1 onto the cross section. Specifically, the direction from the axis center CL to the nose portion N1 is deviated from the direction obtained by orthogonally projecting the suction direction K1 onto the cross section at an angle larger than 0° and smaller than 90° in the rotation direction of the upper centrifugal multi-blade fan 192.

In addition, in any cross section orthogonal to the axis center CL and intersecting with the nose portion N2, a direction from the axis center CL to the nose portion N2 is deviated from the direction obtained by orthogonally projecting the suction direction K1 onto the cross section. Specifically, the direction from the axis center CL to the nose portion N2 is deviated from the direction obtained by orthogonally projecting the suction direction K1 onto the cross section at an angle larger than 90° and smaller than 360° in the rotation direction of the upper centrifugal multi-blade fan 192. Further, specifically, the direction from the axis center CL to the nose portion N2 is deviated from the direction obtained by orthogonally projecting the suction direction K1 onto the cross section at an angle larger than 180° and smaller than 270° in the rotation direction of the upper centrifugal multi-blade fan 192. The rotation direction of the upper centrifugal multi-blade fan 192 is the counterclockwise direction in FIG. 4 as indicated by arrows in FIG. 4.

In addition, the scroll space V1 is not adjacent through only a wall to an adjacent passage in which the blown air BW2 blown from the upper centrifugal multi-blade fan 192 and different from the blown air BW1 flows, in other words, the internal space of the duct 202. In other words, the scroll space V1 is adjacent to the internal space of the duct 202 also through a space where the air outside the upper scroll casing 193 is present. The space is an internal space of the air conditioning case 11 or a space outside the air conditioning case 11.

In addition, the scroll space V2 is not adjacent through only a wall to an adjacent passage in which the blown air BW1 blown from the upper centrifugal multi-blade fan 192 and different from the blown air BW2 flows, in other words, the internal space of the duct 201. In other words, the scroll space V1 is adjacent to the internal space of the duct 202 also through a space where the air outside the upper scroll casing 193 is present. The space is an internal space of the air conditioning case 11 or a space outside the air conditioning case 11.

With the above configuration, a heat exchange between the blown air BW1 and BW2 having different temperatures can be reduced. In FIG. 4, a figure obtained by orthogonally projecting the upper side suction port partition plate 23a on a cross section IV-IV in FIG. 1 is indicated by a broken line.

As shown in FIG. 5, the lower scroll casing 195 is plane symmetric with the opposite side bottom wall 193b as a plane of symmetry. Therefore, the configuration of the lower scroll casing 195 is compatible with that of obvious replacement in the above detailed description of the upper scroll casing 193, and therefore a description of the configuration of the lower scroll casing 195 will be omitted. As a specific replacement, the upper scroll casing 193, the air introduction side bottom wall 193a, and the scroll outer peripheral wall 193c are replaced with the lower scroll casing 195, the air introduction side bottom wall 195a, and the scroll outer peripheral wall 195c, respectively. Further, the upper centrifugal multi-blade fan 192 is replaced by the lower centrifugal multi-blade fan 194. Further, the upper front side space R1 and the upper rear side space R2 are replaced with the lower front side space R3 and the lower rear side space R4, respectively. Also, FIG. 4 is replaced with FIG. 5. Also, the counterclockwise direction is replaced with a clockwise direction. Further, ducts 201 and 202 are replaced by ducts 204 and 205, respectively. Further, the upper side suction port partition plate 23a is replaced by the lower side suction port partition plate 23b.

The scroll inner wall surfaces S1, S2, the nose portions N1, N2, the winding end portions E1, E2, the scroll spaces V1, V2, the outlet spaces X1, X2, and the outlet inner wall surfaces D11, D12, D21, D22 in the lower scroll casing 195 are different from those having the same name and the same reference numeral in the upper centrifugal multi-blade fan 192. However, for simplicity of description, the same reference numerals are denoted. The blown air BW1 and BW2 in the lower scroll casing 195 is different from the blown air with the same reference numeral in the upper centrifugal multi-blade fan 192, but the same reference numerals are given for the sake of simplicity of the description.

Next, the operation of the air conditioning unit 10 according to the present embodiment will be described. When the engine of the vehicle is operating and the air conditioning unit 10 is operating, the refrigeration cycle including the evaporator 13 operates under the control of an air conditioner control computer not shown, and the centrifugal blower 19 operates. In addition, under the control of the air conditioner control computer, the inside/outside air switching door 123 is controlled so as to be located at any one of an inside air mode position, an outside air mode position, and an inside and outside air bilayer mode position.

When the inside/outside air switching door 123 is in the inside air mode position, the outside air from the outside air introduction port 121 is introduced into each of the spaces R1, R2, R3, and R4 by a suction force of the centrifugal blower 19, and the inside air is not introduced into those spaces.

When the inside/outside air switching door 123 is in the inside air mode position, the inside air from the inside air introduction port 122 is introduced into each of the spaces R1, R2, R3, and R4 by the suction force of the centrifugal blower 19, and the outside air is not introduced into those spaces.

When the inside/outside air switching door 123 is in the inside and outside air bilayer mode position, both of the outside air introduction port 121 and the inside air introduction port 122 are opened, and the inside/outside air switching door 123 and the upper and lower partition plate 21 come in contact with each other or are adjacent to each other across an extremely narrow gap. Therefore, in this case, since both of the inside/outside air switching door 123 and the upper and lower partition plate 21 separate the inside air from the outside air, only the inside air is introduced into the spaces R1 and R2, and only the outside air is introduced into the spaces R3 and R4.

The blown air that has flowed into the spaces R1, R2, R3, and R4 passes through the evaporator 13 to exchange heat with the evaporator 13 and a temperature of the blown air decreases to become a cold air. Further, a part of the cold air exchanges heat with the heater core 14, and is warmed into hot air.

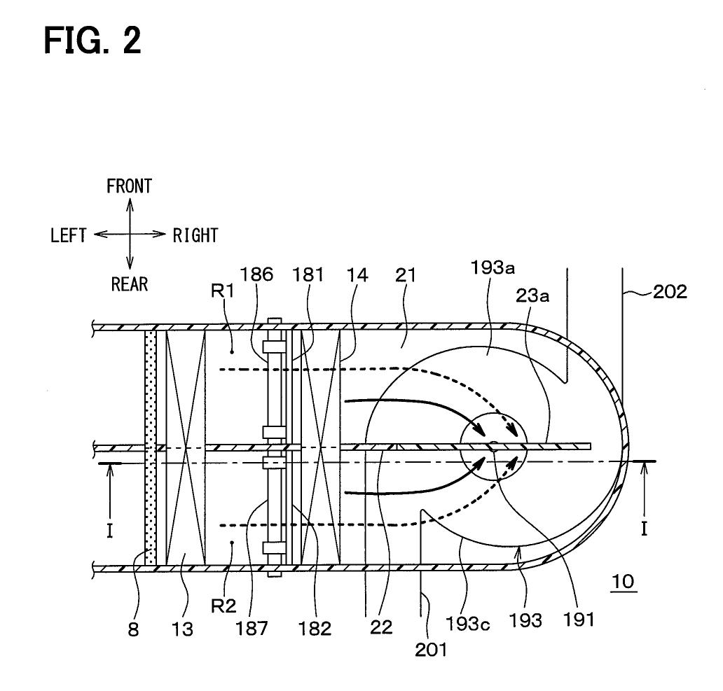

With the suction force of the centrifugal blower 19, the blown air including the hot air and the cold air is suctioned into the centrifugal blower 19. Specifically, as shown in FIG. 2, the blown air in the spaces R1 and R2 passes through the air introduction side bottom wall 193a and enters a fan suction port of the upper centrifugal multi-blade fan 192.

The blown air in the spaces R1 and R2 enters the fan suction port in a state where the blown air is separated from each other by the upper side suction port partition plate 23a, and therefore even at the fan suction port, the blown air is separated to some extent along a line L1 in FIG. 4.

In other words, in the present embodiment, the blown air that has passed through the spaces R1 and R2 is separated from each other and enters into the communication hole of the upper scroll casing 193, and further flows in a direction range different from each other when viewed from the axis center CL of the fan suction port. In other words, the blown air that has passed through the upper front side space R1 flows into the direction range on the vehicle front side of the partition plate 23 when viewed from the axis center CL of the fan suction port. In addition, the blown air that has passed through the upper rear side space R2 flows into the direction range on the vehicle rear side of the partition plate 23 when viewed from the axis center CL of the fan suction port. Therefore, in a portion of the fan suction port on the vehicle front side of the line L1 in FIG. 4, the blown air from the upper front side space R1 advances radially outward around the axis center CL, and flows between any two blades of the multiple blades 192b from an end on the axis center CL side of the two blades. In a portion of the fan suction port on the vehicle rear side of the line L1 in FIG. 4, the blown air from the upper rear side space R2 advances radially outward around the axis center CL, and flows in between any two blades of the multiple blades 192b from an end on the axis center CL side of the two blades.

Thereafter, the blown air flowing in between the two blades flows in a direction away from the axis center CL by a centrifugal force while moving in a circumferential direction around the axis center CL together with the rotation of the two blades. Further, the blown air is blown out in the direction away from the axis center CL from the opposite axis center CL side end of the two blades.

In the cross section of FIG. 4, a direction in which the upper side suction port partition plate 23a extends is deviated from a direction from the axis center CL to the nose portions N1 and N2 by a predetermined deviation angle in a direction opposite to the rotation direction of the upper centrifugal multi-blade fan 192. The deviation angle corresponds to an angle at which the upper centrifugal multi-blade fan 192 rotates since the blown air flows into the two blades until the blown air exits the two blades.

Therefore, most of the blown air blown into the fan suction port from the upper front side space R1 flows into the scroll space V1 facing the scroll inner wall surface S1. Most of the blown air blown into the fan suction port from the upper rear side space R2 flows into the scroll space V2 facing the scroll inner wall surface S2.

As described above, the flow rate vector of the blown air flowing into the fan suction space from the spaces R1 and R2 includes a component in the suction direction K1 in FIG. 4. A movement velocity vector of each blade 192b in the first quadrant has a component in a direction opposite to the suction direction K1. Therefore, after the blown air flowing into the suction space from the upper front side space R1 has flowed in between the two blades, the blown air collides with one of the two blades, to thereby reduce a flow rate.

However, as described above, since the nose portion N1 is disposed in the first quadrant, the blown air whose flow rate has decreased is blown to a side of the scroll space V1 closer to the nose portion N1 than the winding end portion E1, in other words, a side where a distance by which the air flowing in the scroll space V1 from now is long. Therefore, the flow rate of the blown air BW1 in the scroll space V1 is higher than that in the case where the blown air having the reduced flow velocity is blown out to the side close to the winding end portion E1 in the scroll space V1.

As described above, a temperature of the blown air BW1 flowing into the scroll space V1 and a temperature of the blown air BW1 flowing into the scroll space V2 are different from each other, and those blown air passes through the ducts 201 and 202 and is blown to different positions in the vehicle interior.

Specifically, as shown in FIG. 4, the blown air in the spaces R3 and R4 passes through the communication hole of the air introduction side bottom wall 195a and enters a fan suction port of the lower centrifugal multi-blade fan 194.

The flow of air entering the fan suction port of the lower centrifugal multi-blade fan 194 from the spaces R3 and R4 and the flow of the blown air entering the fan suction port of the upper centrifugal multi-blade fan 192 from the spaces R1 and R2 described above are symmetrical with respect to the opposite side bottom wall 193b as a symmetry plane. Therefore, the flow of those blown air is compatible to the blown air entering the fan suction port of the upper centrifugal multi-blade fan 192 from the spaces R1 and R2, which is subjected to the obvious replacement in the above detailed description, and therefore a description of the flow will be omitted.

As a specific replacement, the upper scroll casing 193, the air introduction side bottom wall 193a, and the scroll outer peripheral wall 193c are replaced with the lower scroll casing 195, the air introduction side bottom wall 195a, and the scroll outer peripheral wall 195c, respectively. Further, the blade 192b is replaced by the blade 194b. Further, the upper side suction port partition plate 23a is replaced by the lower side suction port partition plate 23b. Further, the upper front side space R1 and the upper rear side space R2 are replaced with the lower front side space R3 and the lower rear side space R4, respectively. Also, FIG. 4 is replaced with FIG. 5. Further, ducts 201 and 202 are replaced by ducts 204 and 205, respectively.

As described above, in the centrifugal blower 19 according to the present embodiment, all half-lines extending perpendicularly to the axis center CL from the starting point of the axial center CL and passing through the scroll inner wall surface S1 do not pass through the second scroll inner wall surface S2. All half-lines extending perpendicularly to the axis center CL from a starting point of the axial center CL and passing through the scroll inner wall surface S2 do not pass through the scroll inner wall surface S1. The scroll inner wall surface S1 and the scroll inner wall surface S2 are disposed so as to satisfy the above configuration.

Further, from another viewpoint, in any cross section orthogonal to the axis center CL and intersecting with the nose portions N1, N2 and the winding end portion E2, a direction from the axis center CL to the nose portion N1 is outside of a certain angle range. The angle range is an angle range from the nose portion N2 to the winding end portion E2 on the scroll inner wall surface S 2 when viewed from the axis center CL.

In the cross section orthogonal to the axis center CL and intersecting with the nose portions N1, N2, and the winding end portion E1, the direction from the axis center CL to the nose portion N2 is outside of the angle range of the scroll inner wall surface S1 from the nose portion N1 to the winding end portion E1 when viewed from the axis center CL.

In other words, the inner scroll wall surface S1 and the scroll inner wall surface S2 are disposed at positions not overlapping with each other as viewed from the axis center CL. In other words, the scroll inner wall surface S1 and the scroll inner wall surface S2 are disposed so as not to overlap with each other in the radial direction starting from the axis center CL.

Further, in the cross section orthogonal to the axis center CL and intersecting with the scroll inner wall surface S1, the scroll space V1 is not present on both sides of the axis center CL. In other words, two points in the scroll space V1 are not aligned with the axis center CL in a straight line. Further, in the cross section orthogonal to the axis center CL and intersecting with the scroll inner wall surface S2, the scroll space V2 is not present on both sides of the axis center CL. In other words, two points in the scroll space V2 are not aligned with the axis center CL in a straight line.

With the above configuration, there is no case in which the scroll space V2 is further wound outside the scroll space V1 when viewed from the axis center CL, and conversely the scroll space V1 is further wound outside the scroll space V2. Therefore, the size of the upper scroll casing 193, more specifically, a width of the upper scroll casing 193 in the direction orthogonal to the axis center CL can be reduced.

Further, in the present embodiment, the blown air BW1 and BW2 are blown in different directions, independently, thereby being capable of reducing the size of the upper scroll casing 193 as compared with the conventional art.

Further, the scroll casings 193 and 195 are disposed in the air conditioning case 11 forming an air flow passage of the blown air flowing into the vehicle interior, and the plural types of blown airs BW1 and BW2 blown out from the centrifugal multi-blade fans 192 and 194 are led outside the air conditioning case 11. In such a case, with a reduction in the size of the scroll casings 193 and 195, the degree of freedom of placement of other devices in the internal space of the air conditioning case 11 increases.

The scroll inner wall surface S1 curves and extends in a shape surrounding the axis center CL from the nose portion N1. In any cross section orthogonal to the axis center CL and intersecting with the nose portion N1, the direction from the axis center CL to the nose portion N1 deviates from the direction obtained by orthogonally projecting the longitudinal direction onto the cross section with an angle larger than 0° and smaller than 90° in the rotation direction of the fan. With the above configuration, the speed of the blown air in the scroll space V1 can be improved.

In addition, the scroll space V1 is adjacent to an adjacent passage in which the blown air BW2 blown from the centrifugal multi-blade fans 192 and 194 and different from the blown air BW1 flows across the air outside the scroll casings 193 and 195. In addition, the scroll space V2 is adjacent to an adjacent passage in which the blown air BW1 blown from the centrifugal multi-blade fans 192 and 194 and different from the blown air BW2 flows across the air outside the scroll casings 193 and 195. With the above configuration, a heat exchange between the blown air BW1 and BW2 having different temperatures can be reduced.

### Second Embodiment

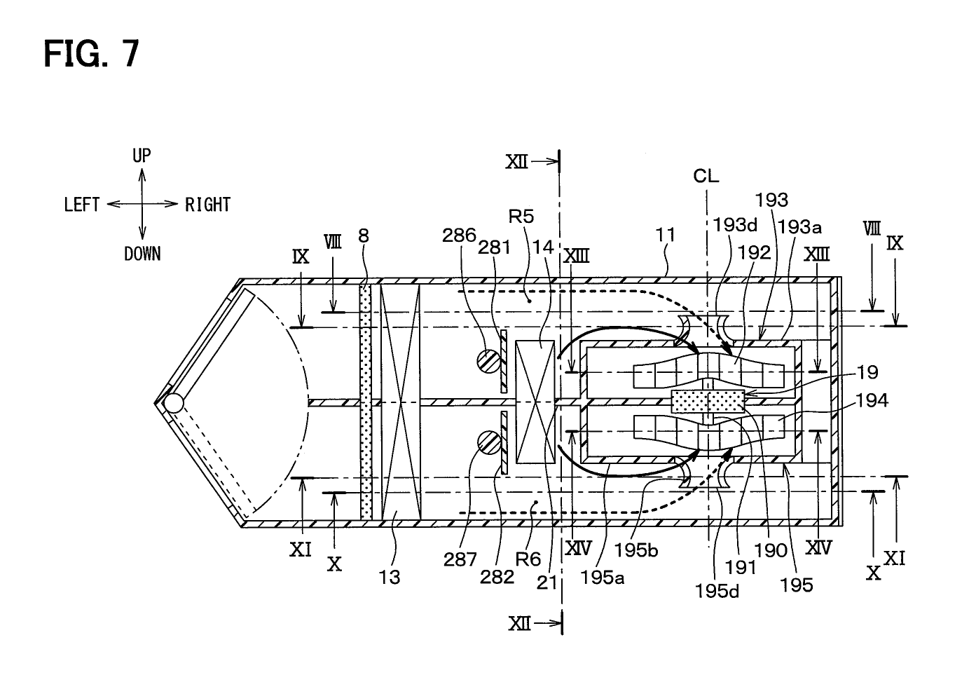

Next, a second embodiment will be described with reference to FIGS. 7 to 14. FIG. 7 is a cross-sectional view of an air conditioning unit 10 in a cross section perpendicular to a longitudinal direction of a vehicle on which the air conditioning unit 10 is mounted according to the present embodiment.

In the air conditioning unit 10 according to the present embodiment, the configuration of the air conditioning unit 10 according to the first embodiment is changed so as to increase the kind of blown air. In the first embodiment, the blown air in the spaces R1 and R2 is suctioned into the upper scroll casing 193, and the blown air in the spaces R3 and R4 is suctioned into the lower scroll casing 195. On the contrary, according to the present embodiment, as shown in FIGS. 7, 8, 9, 10, and 11, an upper central space R5 is disposed between an upper front side space R1 and an upper rear side space R2, and a lower central space R6 is disposed between a lower front side space R3 and a lower rear side space R4.

In order to provide such spaces R5 and R6, the air conditioning unit 10 according to the present embodiment is obtained by modifying the air conditioning unit 10 according to the first embodiment as follows. First, the front and rear partition plate 22 according to the first embodiment is eliminated, and in place of the front and rear partition plate 22, a front-center partition plate 24, a center-rear partition plate 25, and a front-rear partition plate 26 are disposed in an air conditioning case 11.

The front-center partition plate 24 is a flat plate shaped resin member that is fixed to the air conditioning case 11, and a plate surface of the upper and center partition plate 24 is parallel to a vertical direction of the vehicle. With the front-center partition plate 24, the upper front side space R1 and the upper central space R5 are partitioned and the lower front side space R3 and the lower central space R6 are partitioned, in the air conditioning case 11.

The center-rear partition plate 25 is a flat plate shaped resin member that is fixed to the air conditioning case 11, and a plate surface of the center-rear partition plate 25 is parallel to a vertical direction of the vehicle. With the center-rear partition plate 25, the upper central space R5 and the upper rear side space R2 are partitioned and the lower central space R6 and the lower rear side space R4 are partitioned, in the air conditioning case 11.

The front-center partition plate 24 and the center-rear partition plate 25 vertically intersect with the upper and lower partition plate 21 in the air conditioning case 11. The upper and lower partition plate 21 according to the present embodiment partitions the internal space of the air conditioning case 11 into a side of the spaces R1, R2, and R5 and a side of the spaces R3, R4, and R6.

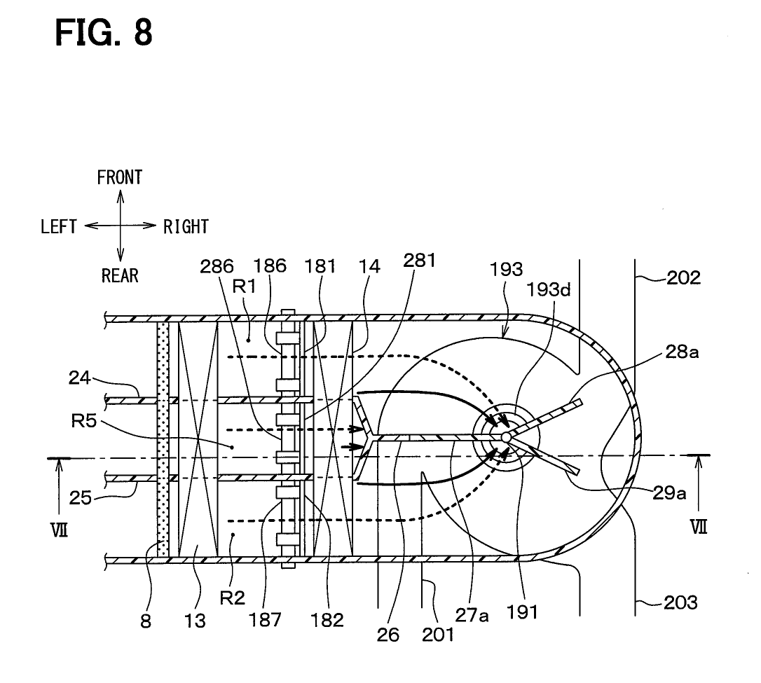

As shown in FIGS. 8 and 12, those partition plates 24 and 25 extend parallel to each other from immediately downstream of an inside/outside air switching door 123 along an air flow to immediately downstream of a heater core 14 along the air flow. However, those partition plates 24 and 25 are connected to each other at a vehicle upper end portion and a vehicle lower end portion immediately downstream of the heater core 14 along the air flow. On the other hand, center portions of the partition plates 24 and 25 in the downward direction of the vehicle extend parallel to each other from immediately downstream of the heater core 14 to a centrifugal blower 19.

In addition, the upper side suction port partition plate 23a according to the first embodiment is replaced by a first upper side suction port partition plate 27a, a second upper side suction port partition plate 28a, and a third upper side suction port partition plate 29a. In addition, the lower side suction port partition plate 23b according to the first embodiment is replaced by a first lower side suction port partition plate 27b, a second lower side suction port partition plate 28b, and a third lower side suction port partition plate 29b.

The partition plates 27a, 28a, and 29a are flat plate shaped resin members that are disposed on the vehicle upper side relative to the centrifugal blower 19, and are fixed to an inner surface of the air conditioning case 11. The partition plates 27a, 28a, and 29a are arranged radially apart from each other by a predetermined angle around an axis center CL. A space sandwiched between the partition plate 27a and the partition plate 28a is a space through which the blown air from the upper front side space R1 passes before entering a communication hole of the upper scroll casing 193. A space sandwiched between the partition plate 27a and the partition plate 29a is a space through which the blown air from the upper rear side space R2 passes before entering a communication hole of the upper scroll casing 193.

The partition plates 27b, 28b, and 29b are flat plate shaped resin members that are disposed on the vehicle lower side relative to the centrifugal blower 19, and are fixed to an inner surface of the air conditioning case 11. The partition plates 27b, 28b, and 29b are arranged radially apart from each other by a predetermined angle around an axis center CL. A space sandwiched between the partition plate 27b and the partition plate 28b is a space through which the blown air from the lower front side space R3 passes before entering a communication hole of the upper scroll casing 193. A space sandwiched between the partition plate 27b and the partition plate 29b is a space through which the blown air from the lower rear side space R4 passes before entering a communication hole of the upper scroll casing 193.

Further, in an air introduction side bottom wall 193a according to the present embodiment, a neck portion 193d is added to an inner edge side surrounding the communication hole as compared with the air introduction side bottom wall 193a according to the first embodiment. The neck portion has a shape in which a predetermined angle range on the right side of the vehicle when viewed from the axis center CL is cut out as compared with a cylinder extending upwardly of the vehicle in a shape in which the center portion in the vertical direction of the vehicle is constricted.

Further, in an air introduction side bottom wall 195a according to the present embodiment, a neck portion 195d is added to an inner edge side surrounding the communication hole as compared with the air introduction side bottom wall 195a according to the first embodiment. The neck portion has a shape in which a predetermined angle range on the right side of the vehicle when viewed from the axis center CL is cut out as compared with a cylinder extending downwardly of the vehicle in a shape in which the center portion in the vertical direction of the vehicle is constricted.

With the partition plate of the above type, the blown air passing through the upper front side space R1 passes through a space between the partition plate 27a and the partition plate 28a, as shown in FIG. 8. The blown air enters the communication hole of the upper scroll casing 193 from the vehicle front side and neck portion 193d, and further enters a fan suction port.

As shown in FIG. 8, the blown air passing through the upper rear side space R2 passes through a space between the partition plate 27a and the partition plate 29a, enters the communication hole of the upper scroll casing 193 from the vehicle rear side and the vehicle upper side of the neck portion 193d, and further enters the fan suction port.

Therefore, in the present embodiment, the blown air that has passed through the spaces R1, R2, and R5 is separated from each other and enters into the communication hole of the upper scroll casing 193, and further flows in a direction range different from each other when viewed from the axis center CL of the fan suction port. In other words, the blown air that has passed through the upper front side space R1 flows into a direction range between the partition plate 27a and the partition plate 28a when viewed from the axis center CL of the fan suction port. The blown air that has passed through the upper rear side space R2 flows into a direction range between the partition plate 27a and the partition plate 29a when viewed from the axis center CL of the fan suction port. The blown air that has passed through the upper central space R2 flows into a direction range between the partition plate 28a and the partition plate 29a when viewed from the axis center CL of the fan suction port.

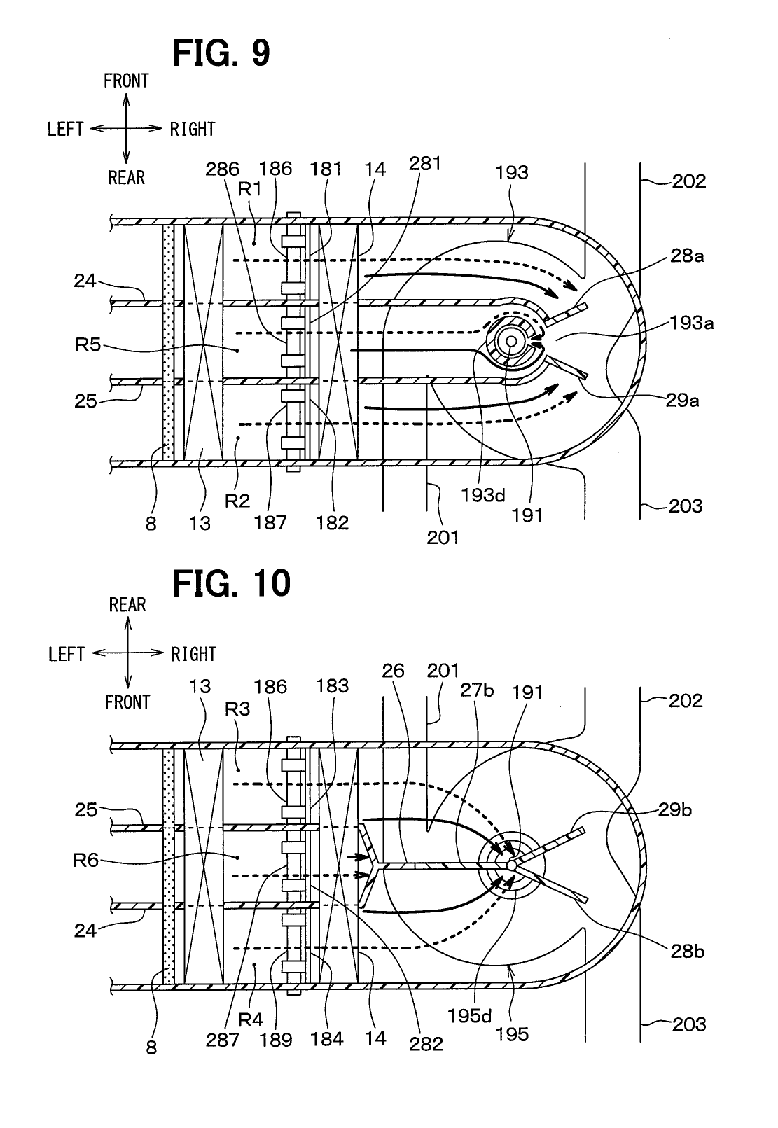

As shown in FIG. 9, after the blown air passing through the upper central space R5 goes through a constricted portion of the neck portion 193d along an outer periphery of the neck portion 193d, the blown air enters the communication hole of the upper scroll casing 193 from a notch of the neck portion 193d, and further enters the fan suction port.

As shown in FIG. 10, the blown air passing through the lower front side space R3 passes through a space between the partition plate 27b and the partition plate 28b, enters the communication hole of the lower scroll casing 195 from the vehicle front side and the vehicle lower side of the neck portion 195d, and further enters the fan suction port.

As shown in FIG. 10, the blown air passing through the lower rear side space R4 passes through a space between the partition plate 27b and the partition plate 29b, enters the communication hole of the lower scroll casing 195 from the vehicle rear side and the vehicle lower side of the neck portion 195d, and further enters the fan suction port.

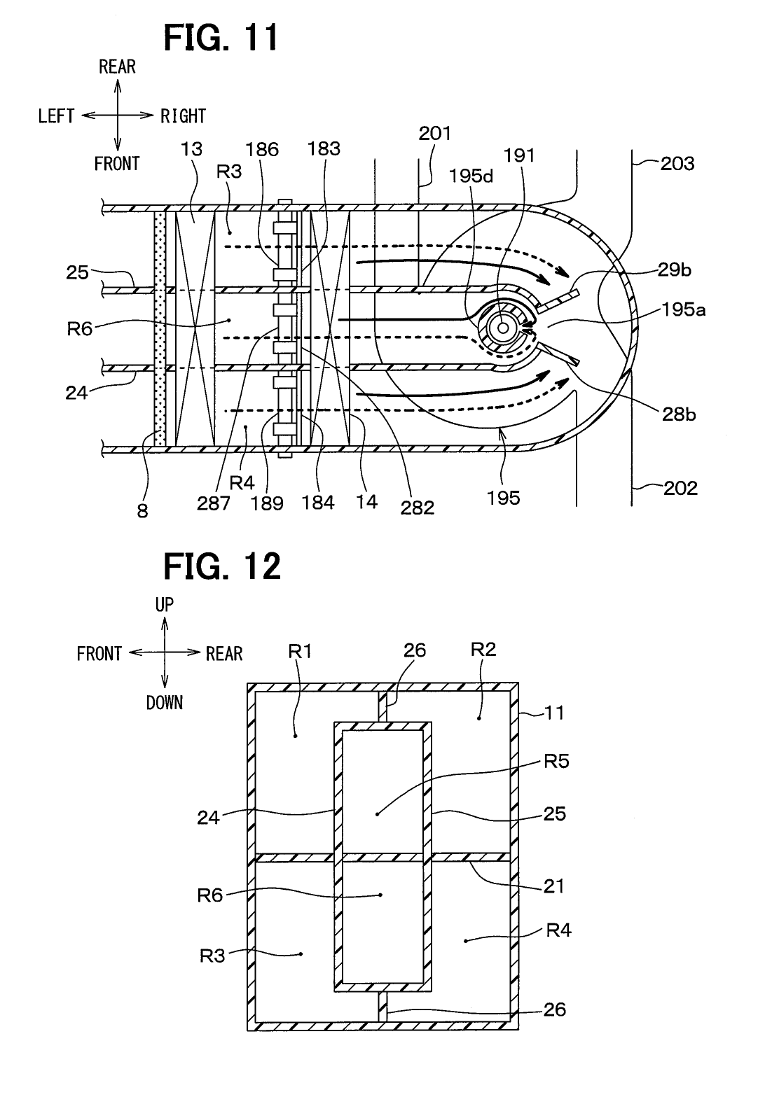

As shown in FIG. 11, after the blown air passing through the lower central space R6 goes through a constricted portion of the neck portion 195d along an outer periphery of the neck portion 195d, the blown air enters the communication hole of the lower scroll casing 195 from a notch of the neck portion 195d, and further enters the fan suction port.

Therefore, in the present embodiment, the blown air that has passed through the spaces R3, R4, and R6 is separated from each other and enters into the communication hole of the lower scroll casing 195, and further flows in a direction range different from each other when viewed from the axis center CL of the fan suction port. In other words, the blown air that has passed through the lower front side space R3 flows into a direction range between the partition plate 27b and the partition plate 28b when viewed from the axis center CL of the fan suction port. The blown air that has passed through the lower rear side space R4 flows into a direction range between the partition plate 27b and the partition plate 29b when viewed from the axis center CL of the fan suction port. The blown air that has passed through the lower central space R6 flows into a direction range between the partition plate 28b and the partition plate 29b when viewed from the axis center CL of the fan suction port.

Further, the air filter 8, the evaporator 13, and the heater core 14 according to the present embodiment are present not only in the spaces R1 to R4 but also in the spaces R5 and R6.

An upper central air mixing door 281 and an upper central door shaft 286 are disposed on the air flow downstream side of the evaporator 13 and on the air flow upstream side of the heater core 14 in the upper central space R5. The upper central air mixing door 281 and the upper central door shaft 286 are members for adjusting an air volume ratio of a cold air and hot air in the upper central space R5.

The upper central air mixing door 281 is a plate-shaped resin member, and is connected to the upper central door shaft 286 so as to be displaceable in the vehicle vertical direction relative to the upper central door shaft 286. The configurations and functions of the upper central air mixing door 281 and the upper central door shaft 286 are comparable to those of the upper front side air mixing door 181 and the upper rear side air mixing door 182, respectively.

A lower central air mixing door 282 and a lower central door shaft 287 are disposed on the air flow downstream side of the evaporator 13 and on the air flow upstream side of the heater core 14 in the lower central space R6. The lower central air mixing door 282 and the lower central door shaft 287 are members for adjusting an air volume ratio of the cold air and the hot air in the lower central space R6. The configurations and functions of the lower central air mixing door 282 and the lower central door shaft 287 are comparable to those of the upper front side air mixing door 181 and the upper rear side air mixing door 182, respectively.

With the configuration described above, the temperatures of the blown air in the spaces R1, R2, R3, R4, R5, and R6 can be adjusted independently, for example, so as to be different from each other.

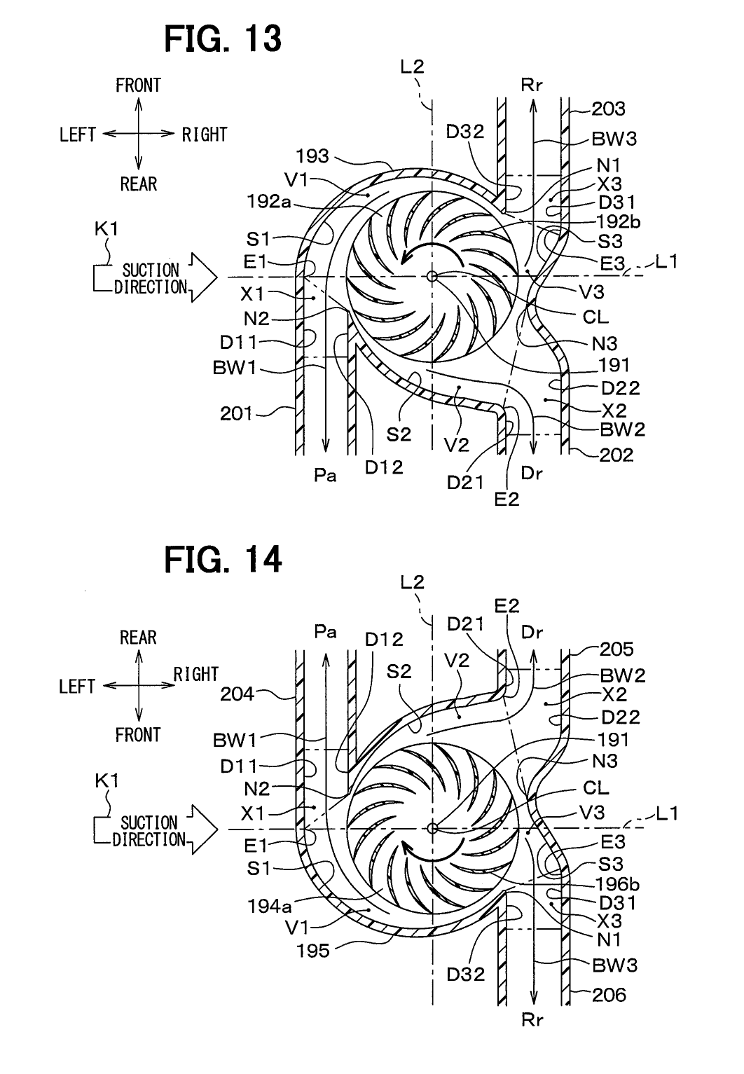

Now, the configuration of the upper scroll casing 193 will be described with a focus on parts modified from the first embodiment. As shown in FIG. 13, the upper scroll casing 193 according to the present embodiment adds a scroll inner wall surface S3, a nose portion N3, a winding end portion E3, a scroll space V3, and an outlet space X3 with respect to the scroll inner wall surfaces S1, S2, the nose portions N1, N2, the winding end portions E1, E2, the scroll spaces V1, V2, and the outlet spaces X1, X2 of the first embodiment, respectively. In order to add the scroll inner wall surface S3, the nose portion N3, the winding end portion E3, the scroll space V3, and the outlet space X3, the position of the duct 202 is changed, and the lengths of the scroll inner wall surface S2 and the scroll space V2 are also changed.

The scroll inner wall surface S3 faces a scroll space V3 that guides a blown air BW3 suctioned into the upper centrifugal multi-blade fan 192 after having passed through the upper central space R5 and then blown out in the internal space of the upper scroll casing 193. The scroll inner wall surface S3 corresponds to an example of the second scroll inner wall surface. The blown air BW3 corresponds to an example of the second kind of blown air.

The scroll inner wall surface S3 extends from the nose portion N3 to a winding end portion E3 so that a distance from the axis center CL increases toward a counterclockwise direction in FIG. 13 according to a well-known logarithmic spiral function with respect to a winding angle around the axis center CL. Therefore, the scroll inner wall surface S3 curves and extends in a shape surrounding the axis center CL.

The nose portion N3 is located on the most upstream side in the air flow of the blown air BW3 on the scroll inner wall surface S3 and the winding end portion E3 is located on the most downstream side of the blown air BW3 along the air flow on the scroll inner wall surface S3. The nose portion N3 corresponds to an example of a second nose portion, and the winding end portion E3 corresponds to an example of a second winding end. As with the back surface sides of the nose portions N1 and N2, the back surface side of the nose N3 on the scroll outer peripheral wall 193c faces the space where the air outside the upper scroll casing 193 is present.

The outlet inner wall surface D31 is a substantially planar shape surface extending from the winding end portion E3 of the scroll inner wall surface S3 to the outside of the air conditioning case 11. The outlet inner wall surface D32 is a substantially planar shape surface extending from the nose portion N1 of the scroll inner wall surface S1 to the outside of the air conditioning case 11, and is disposed to face the outlet inner wall surface D31.

The outlet inner wall surface D22 of the present embodiment is modified as a curved surface extending from the nose portion N3 of the scroll inner wall surface S3 to the outside of the air conditioning case 11 with the provision of the scroll inner wall surface S3.

The outlet space X3 surrounded by the outlet inner wall surfaces D31, D32, the air introduction side bottom wall 193a, and the opposite side bottom wall 193b communicates with the scroll space V3 and further communicates with the internal space of the duct 203 different from the ducts 201 and 202. Therefore, the blown air BW3 blown out from the upper centrifugal multi-blade fan 192 is led to the outlet space X3 through the scroll space V3 and then blown further into the vehicle interior through the internal space of the duct 203. As described above, the scroll inner wall surface S3 is formed in a shape that guides the blown air BW3 blown from the upper centrifugal multi-blade fan 192 to the outlet space X3 and the internal space of the duct 203.

In the present embodiment, the blown air passing through the scroll space V1, the outlet space X1, and the internal space of the duct 201 is blown toward a front passenger seat from a front passenger seat blowing port Pa in the vehicle interior. The blown air that has passed through the scroll space V2, the outlet space X2, and the internal space of the duct 202 is blown toward a driver's seat from a driver's seat blowing port Dr in the vehicle interior. The blown air that has passed through the scroll space V3, the outlet space X3, and the internal space of the duct 203 is blown toward the front passenger seat from a rear seat blowing port Rr in the vehicle interior.

Now, a relative placement of the scroll inner wall surfaces S1, S2, and S3 will be described. The scroll inner wall surfaces S1, S2, and S3 are arranged at different positions when viewed from the axis center CL, and the scroll inner wall surface S1, the scroll inner wall surface S2, and the scroll inner wall surface S3 are aligned along the rotation direction of the upper centrifugal multi-blade fan 192 in the stated order.

Cross sections orthogonal to the axis center CL and intersecting with the nose portion N1, the nose portion N2, and the winding end portion E2 can be defined. In any cross section described above, a direction from the axis center CL to the nose portion N1 is outside of an angle range of the scroll inner wall surface S2 from the nose portion N2 to the winding end portion E2 when viewed from the axis center CL.

Cross sections orthogonal to the axis center CL and intersecting with the nose portion N1, the nose portion N3, and the winding end portion E3 can be defined. In any cross section described above, a direction from the axis center CL to the nose portion N1 is outside of an angle range of the scroll inner wall surface S3 from the nose portion N3 to the winding end portion E3 when viewed from the axis center CL.

Cross sections orthogonal to the axis center CL and intersecting with the nose portion N2, the nose portion N1, and the winding end portion E1 can be defined. In any cross section described above, a direction from the axis center CL to the nose portion N2 is outside of an angle range of the scroll inner wall surface S1 from the nose portion N1 to the winding end portion E1 when viewed from the axis center CL.

Cross sections orthogonal to the axis center CL and intersecting with the nose portion N2, the nose portion N3, and the winding end portion E3 can be defined. In any cross section described above, a direction from the axis center CL to the nose portion N2 is outside of an angle range of the scroll inner wall surface S3 from the nose portion N3 to the winding end portion E3 when viewed from the axis center CL.

Cross sections orthogonal to the axis center CL and intersecting with the nose portion N3, the nose portion N1, and the winding end portion E1 can be defined. In any cross section described above, a direction from the axis center CL to the nose portion N3 is outside of an angle range of the scroll inner wall surface S1 from the nose portion N1 to the winding end portion E1 when viewed from the axis center CL.

Cross sections orthogonal to the axis center CL and intersecting with the nose portion N3, the nose portion N2, and the winding end portion E2 can be defined. In any cross section described above, a direction from the axis center CL to the nose portion N3 is outside of an angle range of the scroll inner wall surface S2 from the nose portion N2 to the winding end portion E2 when viewed from the axis center CL.

In other words, the direction range of the scroll inner wall surface S1 when viewed from the axis center CL and the direction ranges of the scroll inner wall surface S2 and the scroll inner wall surface S3 do not overlap with each other at all.

Therefore, all half-lines extending perpendicularly to the axis center CL from a starting point of the axial center CL and passing through the scroll inner wall surface S1 do not pass through the scroll inner wall surfaces S2 and S3. Therefore, all half-lines extending perpendicularly to the axis center CL from a starting point of the axial center CL and passing through the scroll inner wall surface S2 do not pass through the scroll inner wall surfaces S1 and S3. Therefore, all half-lines extending perpendicularly to the axis center CL from a starting point of the axial center CL and passing through the scroll inner wall surface S3 do not pass through the scroll inner wall surfaces S1 and S2.

In other words, the scroll inner wall surfaces S1, S2, and S3 are disposed at positions not overlapping with each other when viewed from the axis center CL. In other words, the scroll inner wall surfaces S1, S2, and S3 are disposed so as not to overlap with each other in the radial direction starting from the axis center CL.

Further, in the cross section orthogonal to the axis center CL and intersecting with the scroll inner wall surface S1, the scroll space V1 is not present on both sides of the axis center CL. In other words, two points in the scroll space V1 are not aligned with the axis center CL in a straight line. Further, in the cross section orthogonal to the axis center CL and intersecting with the scroll inner wall surface S2, the scroll space V2 is not present on both sides of the axis center CL. In other words, two points in the scroll space V2 are not aligned with the axis center CL in a straight line. Further, in the cross section orthogonal to the axis center CL and intersecting with the scroll inner wall surface S3, the scroll space V3 is not present on both sides of the axis center CL. In other words, two points in the scroll space V3 are not aligned with the axis center CL in a straight line.

With the above configuration, as in the first embodiment, the size of the upper scroll casing 193, more specifically, a width of the upper scroll casing 193 in the direction orthogonal to the axis center CL can be reduced.

In particular, as shown in FIG. 13, since a width W of the upper scroll casing 193 of the internal space of the air conditioning case 11 in a longitudinal direction K1 can be kept small in the air conditioning case 11, the degree of freedom of placement of the other devices in the internal space of the air conditioning case 11 in the longitudinal direction increases.

As in the first embodiment, in any cross section orthogonal to the axis center CL and intersecting with the nose portion N1, a direction from the axis center CL to the nose portion N1 is deviated from the direction obtained by orthogonally projecting the suction direction K1 onto the cross section. Specifically, the direction from the axis center CL to the nose portion N1 is deviated from the direction obtained by orthogonally projecting the suction direction K1 onto the cross section at an angle larger than 0° and smaller than 90° in the rotation direction of the upper centrifugal multi-blade fan 192. Therefore, as described in the first embodiment, a flow layer of the blown air BW1 in the scroll space V1 can be increased.

In addition, in any cross section orthogonal to the axis center CL and intersecting with the nose portions N2 and N3, a direction from the axis center CL to the nose portions N2 and N3 is deviated from the direction obtained by orthogonally projecting the suction direction K1 onto the cross section. Specifically, the direction from the axis center CL to the nose portions N1 and N3 is deviated from the direction obtained by orthogonally projecting the suction direction K1 onto the cross section at an angle larger than 90° and smaller than 360° in the rotation direction of the upper centrifugal multi-blade fan 192. More specifically, the direction from the axis center CL to the nose portions N2 and N3 is deviated from the direction obtained by orthogonally projecting the suction direction K1 onto the cross section at an angle larger than 180° and smaller than 270°.

In addition, the scroll space V1 is not adjacent through only a wall to an adjacent passage in which the blown air BW3 blown from the upper centrifugal multi-blade fan 192 and different from the blown air BW1 flows, in other words, the internal space of the duct 203. In other words, the scroll space V1 is adjacent to the internal space of the duct 202 also through a space where the air outside the upper scroll casing 193 is present. The space is an internal space of the air conditioning case 11 or a space outside the air conditioning case 11.

In addition, the scroll space V2 is not adjacent through only a wall to an adjacent passage in which the blown air BW1 blown from the upper centrifugal multi-blade fan 192 and different from the blown air BW2 flows, in other words, the internal space of the duct 201. In other words, the scroll space V2 is adjacent to the internal space of the duct 202 also through a space where the air outside the upper scroll casing 193 is present. The space is an internal space of the air conditioning case 11 or a space outside the air conditioning case 11.

In addition, the scroll space V3 is not adjacent through only a wall to an adjacent passage in which the blown air BW2 blown from the upper centrifugal multi-blade fan 192 and different from the blown air BW3 flows, in other words, the internal space of the duct 202. In other words, the scroll space V3 is adjacent to the internal space of the duct 202 also through a space where the air outside the upper scroll casing 193 is present. The space is an internal space of the air conditioning case 11 or a space outside the air conditioning case 11. With the above configuration, a heat exchange between the blown air BW1, BW2 and BW3 having different temperatures can be reduced.

As shown in FIG. 14, the lower scroll casing 195 is plane symmetric with the opposite side bottom wall 193b as a plane of symmetry. Therefore, the configuration of the lower scroll casing 195 is compatible with that of obvious replacement in the above detailed description of the upper scroll casing 193, and therefore a description of the configuration of the lower scroll casing 195 will be omitted. As a specific replacement, the upper scroll casing 193, the air introduction side bottom wall 193a, and the scroll outer peripheral wall 193c are replaced with the lower scroll casing 195, the air introduction side bottom wall 195a, and the scroll outer peripheral wall 195c, respectively. Further, the upper centrifugal multi-blade fan 192 is replaced by the lower centrifugal multi-blade fan 194. Further, the upper front side space R1, the upper rear side space R2, and the upper central space R5 are replaced with the lower front side space R3, the lower rear side space R4, and the lower central space R6, respectively. Also, FIG. 13 is replaced with FIG. 14. Also, the counterclockwise direction is replaced with a clockwise direction. Further, ducts 201, 202, and 203 are replaced by ducts 204, 205, and 206, respectively. In addition, the partition plates 27a, 28a, and 29a are replaced with the partition plates 27b, 28b, and 29b, respectively.

The scroll inner wall surfaces S1, S2, S3, the nose portions N1, N2, N3, the winding end portions E1, E2, E3 the scroll spaces V1, V2, V3, the outlet spaces X1, X2, X3, and the outlet inner wall surfaces D11, D12, D21, D22, D31, D32 in the lower scroll casing 195 are different from those having the same name and the same reference numeral in the upper centrifugal multi-blade fan 192. However, for simplicity of description, the same reference numerals are denoted. The blown air BW1, BW2, and BW3 in the lower scroll casing 195 is different from the blown air with the same reference numeral in the upper centrifugal multi-blade fan 192, but the same reference numerals are given for the sake of simplicity of the description.

Next, the operation of the air conditioning unit 10 according to the present embodiment will be described focusing on a changed portion of the first embodiment. During the operation of the air conditioning unit 10, the blown air in the spaces R1, R2 and R5 enters the fan suction port in a state where the blown air is separated from each other by the upper side suction port partition plate 23a. Therefore, also in the fan suction port, as described above, the direction ranges of the respective blown air when viewed from the axis center CL are separated to some extent.

In other words, in the present embodiment, the blown air that has passed through the spaces R1, R2, and R5 is separated from each other and enters into the communication hole of the upper scroll casing 193, and further flows in a direction range different from each other when viewed from the axis center CL of the fan suction port. In other words, the blown air that has passed through the upper front side space R1 flows into a direction range between the partition plate 27a and the partition plate 28a when viewed from the axis center CL of the fan suction port. The blown air that has passed through the upper rear side space R2 flows into a direction range between the partition plate 27a and the partition plate 29a when viewed from the axis center CL of the fan suction port. The blown air that has passed through the upper central space R5 flows into a direction range between the partition plate 28a and the partition plate 29a when viewed from the axis center CL of the fan suction port.

The blown air in the respective direction ranges in the fan suction port advances radially outward around the axis center CL, and flows in between any two blades of the multiple blades 192b from the axis center CL side end of the two blades.

Thereafter, the blown air flowing in between the two blades flows in a direction away from the axis center CL by a centrifugal force while moving in a circumferential direction around the axis center CL together with the rotation of the two blades. The blown air is blown out in the direction away from the axis center CL from the opposite axis center CL side end of the two blades.

Most of the blown air blown into the fan suction port from the upper front side space R1 flows into the scroll space V1 facing the scroll inner wall surface S1. Most of the blown air blown into the fan suction port from the upper rear side space R2 flows into the scroll space V2 facing the scroll inner wall surface S2. Most of the blown air blown into the fan suction port from the upper central space R5 flows into the scroll space V3 facing the scroll inner wall surface S3.

The flow of air entering the fan suction port of the lower centrifugal multi-blade fan 194 from the spaces R3, R4, and R6 and the flow of the blown air entering the fan suction port of the upper centrifugal multi-blade fan 192 from the spaces R1, R2, and R5 described above are symmetrical with respect to the opposite side bottom wall 193b as a symmetry plane. Therefore, the flow of those blown air is compatible to the blown air entering the fan suction port of the upper centrifugal multi-blade fan 192 from the spaces R1, R2, and R5 which is subjected to the obvious replacement in the above detailed description, and therefore a description of the flow will be omitted.

As a specific replacement, the upper scroll casing 193, the air introduction side bottom wall 193a, and the scroll outer peripheral wall 193c are replaced with the lower scroll casing 195, the air introduction side bottom wall 195a, and the scroll outer peripheral wall 195c, respectively. Further, the blade 192b is replaced by the blade 194b. In addition, the partition plates 27a, 28a, and 29a are replaced with the partition plates 27b, 28b, and 29b, respectively. Also, the spaces R1, R2 and R5 are replaced with the spaces R3, R4 and R6, respectively. Also, FIG. 13 is replaced with FIG. 14. Further, ducts 201, 202, and 203 are replaced by ducts 204, 205, and 206, respectively.

### Other Embodiments

It should be noted that the present disclosure is not limited to the embodiments described above, and can be appropriately modified. In addition, each of the above-described embodiments is related to each other, and can be appropriately combined with each other except for a case where the combination is apparently impossible. In the above-described respective embodiments, elements configuring the embodiments are not necessarily indispensable as a matter of course, except when the elements are particularly specified as indispensable and the elements are considered as obviously indispensable in principle. In the above-described respective embodiments, when numerical values such as the number, figures, quantity, a range of configuration elements in the embodiments are described, the numerical values are not limited to a specific number, except when the elements are particularly specified as indispensable and the numerical values are obviously limited to the specific number in principle. Particularly, in the case where multiple values are exemplified for a certain amount, a value between the multiple values can be employed, unless otherwise stated or where it is clearly impossible in principle. In the above-described respective embodiments, when a shape, a positional relationship, and the like of a configuration element and the like are mentioned, the shape, the positional relationship, and the like are not limited thereto excluding a particularly stated case and a case of being limited to specific shape, positional relationship, and the like based on the principle. The present disclosure encompasses the following modifications of the respective embodiments described above. The following modifications are independently capable of selecting whether to be applied or not applied to the embodiments described above. In other words, an arbitrary combination of the following modifications is capable of being applied to the above-described embodiments.

### Modification 1

In each of the above embodiments, centrifugal multi-blade fans 192 and 194 are disposed at the center in the vertical direction of the vehicle in the internal space of the air conditioning case 11, as shown in FIGS. 1 and 7. However, the placement of the centrifugal multi-blade fans 192 and 194 is not limited to such an example.

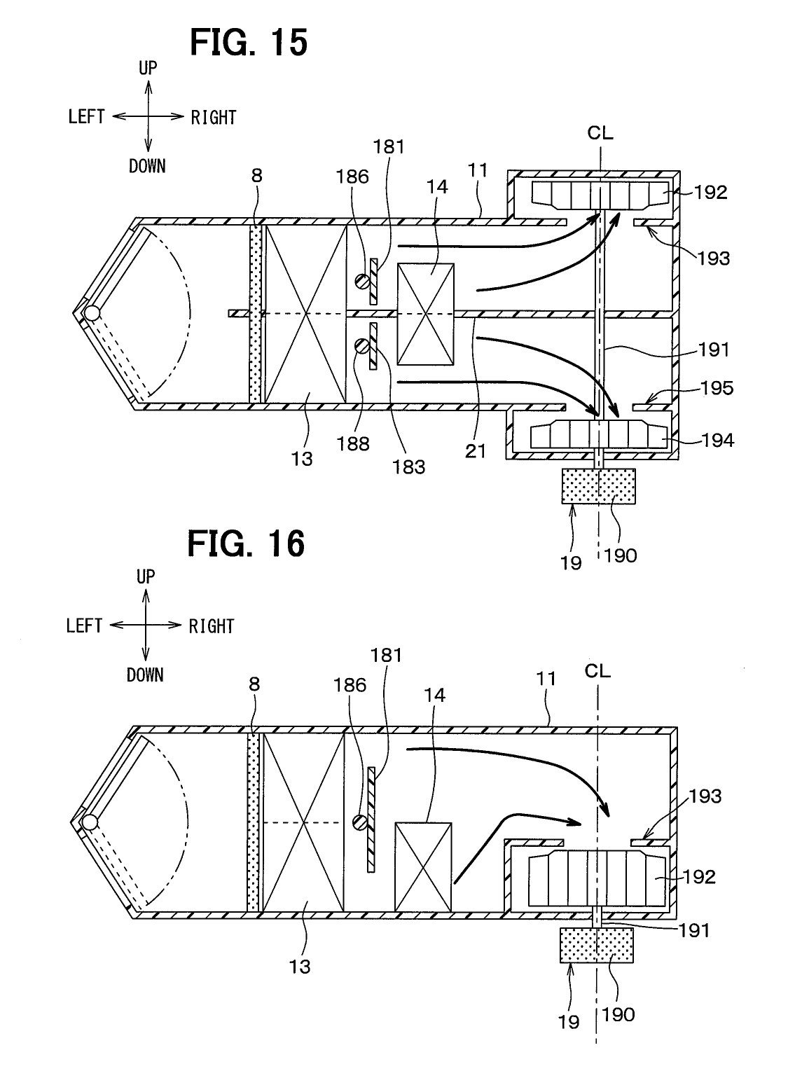

For example, as shown in FIG. 15, centrifugal multi-blade fans 192 and 194 may be disposed separately at an upper end and a lower end in a vertical direction of a vehicle in an internal space of an air conditioning case 11. Alternatively, as shown in FIG. 16, only an upper centrifugal multi-blade fan 192 may be disposed in the air conditioning case 11 with the elimination of the lower centrifugal multi-blade fan 194.

### Modification 2

Further, in the first embodiment, the upper side suction port partition plate 23a may be rotatable about the axis center CL as a rotation axis. In this case, a rotation angle of an upper side suction port partition plate 23a and a lower side suction port partition plate 23b may be changed to an angle at which most of the blown air in spaces R1 and R2 are blown to scroll spaces V1 and V2, respectively, based on positions of the respective air mixing doors 181 and 182. The same is applied to the lower side suction port partition plate 23b.

Further, in the second embodiment, the partition plates 27a, 28a, and 29a may be rotatable about the axis center CL as a rotation axis. In this case, the rotation angles of the partition plates 27a, 28a, and 29a may be changed to an angle at which most of the blown air in spaces R1, R2, and R5 are blown to scroll spaces V1, V2, and V3, respectively, based on positions of the respective air mixing doors 181, 182, and 281. The same is applied to the partition plates 27b, 28b, and 29b.

### Modification 3

In each of the above embodiments, the centrifugal blower 19 is illustrated as an example of the blower, but the present disclosure is not limited to the centrifugal blower, but extends to an axial flow blower.

What is claimed is:

1. A blower comprising:
a fan that suctions and blows a plurality of kinds of blown air at different temperatures while rotating around an axis center; and
a casing that guides the plurality of kinds of blown air blown out from the fan, wherein
the casing includes a peripheral wall that is located radially outward of the fan with the axis center as a center,
the peripheral wall includes a first scroll inner wall surface that curves and extends in a shape surrounding the axis center and a second scroll inner wall surface that curves and extends in a shape surrounding the axis center,
the first scroll inner wall surface is formed in a shape that guides a first type of blown air blown from the fan to a first outlet space,
the second scroll inner wall surface is formed in a shape that guides a second type of blown air blown from the fan and different in temperature from the first type of blown air to a second outlet space different from the first outlet space, and
the first scroll inner wall surface and the second scroll inner wall surface are disposed so as not to overlap with each other in a radial direction starting from the axis center.

2. The blower according to claim 1, wherein
the first scroll inner wall surface and the second scroll inner wall surface are disposed in a state where all half-lines extending perpendicularly to the axis center with the axis center as a starting point and passing through the first scroll inner wall surface do not pass through the second scroll inner wall surface, and all half-lines extending perpendicularly to the axis center with the axis center as a starting point and passing through the second scroll inner wall surface do not pass through the first scroll inner wall surface.

3. The blower according to claim 1, wherein
the first scroll inner wall surface extends from a first nose portion located on an upstream side of a flow of the first type of blown air to a first winding end portion located on a downstream side of the flow of the first type of blown air,
the second scroll inner wall surface extends from a second nose portion located on an upstream side of a flow of the second type of blown air to a second winding end portion located on the downstream side of the flow of the second type of blown air,
in a cross section orthogonal to the axis center and intersecting with the first nose portion, the second nose portion, and the second winding end portion, a direction from the axis center to the first nose portion is outside of an angle range from the second nose portion to the second winding end portion on the second scroll inner wall surface when viewed from the axis center, and
in a cross section orthogonal to the axis center and intersecting with the second nose portion, the first nose portion, and the first winding end portion, a direction from the axis center to the second nose portion is outside of an angle range from the first nose portion to the first winding end portion on the first scroll inner wall surface when viewed from the axis center.

4. The blower according to claim 1, wherein
the casing is disposed in an air conditioning case providing an air flow passage of the blown air blown to the vehicle interior, and guides the plurality of kinds of blown air blown out from the fan to the outside of the air conditioning case.

5. The blower according to claim 4, wherein
a cooling unit that cools the blown air flowing in the air conditioning case, a heating unit that heats the blown air flowing in the air conditioning case, and the fan are aligned in an internal space of the air conditioning case along a longitudinal direction of the internal space,
the first scroll inner wall surface is curved and extended in a shape surrounding the axis center from a first nose portion located on a most upstream side of the flow of the first kind of blown air, and
in a cross section orthogonal to the axis center and intersecting with the first nose portion, a direction from the axis center to the first nose portion is deviated at an angle greater than 0° and less than 90° in a rotational direction of the fan with respect to a direction obtained by orthogonally projecting the longitudinal direction to this cross section.

6. The blower according to claim 1, wherein
a scroll space that faces the first scroll inner wall surface and in which the first kind of blown air flows is adjacent to an adjacent passage in which the blown air blown from the fan and different than the first kind of blown air flows, the scroll space being adjacent to the adjacent passage through a space in which air outside the casing is present.

7. A blower comprising:
a fan that suctions and blows a plurality of kinds of blown air at different temperatures while rotating around an axis center; and
a casing that guides the plurality of kinds of blown air blown out from the fan, wherein
the casing includes a peripheral wall that is located radially outward of the fan with the axis center as a center,
the peripheral wall includes a first scroll inner wall surface that curves and extends in a shape surrounding the axis center and a second scroll inner wall surface that curves and extends in a shape surrounding the axis center,
the first scroll inner wall surface is formed in a shape that guides a first type of blown air blown from the fan to a first outlet space,
the second scroll inner wall surface is formed in a shape that guides a second type of blown air blown from the fan and different in temperature from the first type of blown air to a second outlet space different from the first outlet space,
the first scroll inner wall surface extends from the first nose portion located on the upstream side of the flow of the first kind of blown air to the downstream side of the flow of the first kind of blown air, and a back surface side of the first nose portion on the peripheral wall faces a space in which air outside the casing is present, and
the second scroll inner wall surface extends from the second nose portion located on the upstream side of the flow of the second kind of blown air to the downstream side of the flow of the first kind of blown air, and a back surface side of the second nose portion on the peripheral wall faces the space in which the air outside the casing is present.
